(19) United States
(12) Patent Application Publication
(10) Pub. No.: US 2013/0174160 A1
(43) Pub. Date: Jul. 4, 2013

(54) Aquiring and transmitting tasks and subtasks to interface devices, and obtaining results of executed subtasks

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(73) Assignee: Elwha LLC, a limited liability company of the State of Delaware

(21) Appl. No.: 13/374,529

(22) Filed: Dec. 30, 2011

Related U.S. Application Data
(63) Continuation-in-part of application No. 13/374,512, filed on Dec. 30, 2011.
Application No. 13/374,512 is a continuation-in-part of application No. 13/374,514, filed on Dec. 30, 2011.
Application No. 13/374,514 is a continuation-in-part of application No. 13/374,511, filed on Dec. 30, 2011.
Application No. 13/374,511 is a continuation-in-part of application No. 13/374,518, filed on Dec. 30, 2011.
Application No. 13/374,518 is a continuation-in-part of application No. 13/374,522, filed on Dec. 30, 2011.
Application No. 13/374,522 is a continuation-in-part of application No. 13/341,901, filed on Dec. 30, 2011.

(51) Int. Cl. G06F 9/46

(52) U.S. Cl. 718/100

(57) ABSTRACT

Computationally implemented methods and systems include receiving a request to carry out a task of acquiring data requested by a task requestor, acquiring one or more subtasks related to the task of acquiring data and configured to be carried out by discrete interface devices in an absence of information regarding the at least one task and/or the task requestor, and obtaining a result of one or more executed subtasks executed by at least two of the discrete interface devices in the absence of information regarding the at least one task and/or the task requestor. In addition to the foregoing, other aspects are described in the claims, drawings, and text.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

For purposes of the USPTO extra-statutory requirements, the present application constitutes a continuation-in-part of U.S. patent application Ser. No. 13/200,553, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 23, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/200,797, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,591, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 21, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,833, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 28, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,795, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,794, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,826, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,829, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled RECEIVING SUBTASK REPRESENTATIONS, AND OBTAINING AND COMMUNICATING SUBTASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled RECEIVING SUBTASK REPRESENTATIONS, AND OBTAINING AND COMMUNICATING SUBTASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled RECEIVING DISCRETE INTERFACE DEVICE SUBTASK RESULT DATA AND ACQUIRING TASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled RECEIVING DISCRETE INTERFACE DEVICE SUBTASK RESULT DATA AND ACQUIRING TASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

### BACKGROUND

This application is related to using interface devices to collect data.

### SUMMARY

A computationally implemented method includes, but is not limited to receiving a request to carry out a task of acquiring data requested by a task requestor, acquiring one or more subtasks related to the task of acquiring data and configured to be carried out by discrete interface devices in an absence of information regarding the at least one task and/or the task requestor, and obtaining a result of one or more executed subtasks executed by at least two of the discrete interface devices in the absence of information regarding the at least one task and/or the task requestor. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein-referenced method aspects depending upon the design choices of the system designer.

A computationally implemented system includes, but is not limited to means for receiving a request to carry out a task of acquiring data requested by a task requestor, means for acquiring one or more subtasks related to the task of acquiring data and configured to be carried out by discrete interface devices in an absence of information regarding the at least one task and/or the task requestor, and means for obtaining a result of one or more executed subtasks executed by at least two of the discrete interface devices in the absence of information regarding the at least one task and/or the task requestor. In addition to the foregoing, other system aspects are described in the claims, drawings, and text forming a part of the present disclosure.

A computationally implemented system includes, but is not limited to circuitry for receiving a request to carry out a task of acquiring data requested by a task requestor, circuitry for acquiring one or more subtasks related to the task of acquiring data and configured to be carried out by discrete interface devices in an absence of information regarding the at least one task and/or the task requestor, and circuitry for obtaining a result of one or more executed subtasks executed by at least two of the discrete interface devices in the absence of information regarding the at least one task and/or the task requestor.

A computer program product comprising an article of manufacture bears instructions including but not limited to one or more instructions for receiving a request to carry out a task of acquiring data requested by a task requestor, one or more instructions for acquiring one or more subtasks related to the task of acquiring data and configured to be carried out by discrete interface devices in an absence of information regarding the at least one task and/or the task requestor, and one or more instructions for obtaining a result of one or more executed subtasks executed by at least two of the discrete interface devices in the absence of information regarding the at least one task and/or the task requestor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of an interface device operating in an exemplary environment 100, according to an embodiment.

FIG. 2, including FIGS. 2A-2B, shows a particular perspective of the task of acquiring data request receiving module 52 of the computing device 30 of environment 100 of FIG. 1.

FIG. 3, including FIGS. 3A-3C, shows a particular perspective of the related absent information configured subtask acquiring module 54 of the computing device 30 of environment 100 of FIG. 1.

FIG. 4, including FIGS. 4A-FG, shows a particular perspective of the two-or-more absent information discrete interface device-executed subtask obtaining module 56 of the computing device 30 of environment 100 of FIG. 1.

FIG. 5 is a high-level logic flowchart of a process, e.g., operational flow 500, according to an embodiment.

FIG. 6A is a high-level logic flowchart of a process depicting alternate implementations of a receiving a request to carry out a task of acquiring data requested by a task requestor operation 502 of FIG. 5.

FIG. 6B is a high-level logic flowchart of a process depicting alternate implementations of a receiving a request to carry out a task of acquiring data requested by a task requestor operation 502 of FIG. 5

FIG. 7A is a high-level logic flowchart of a process depicting alternate implementations of an acquiring one or more subtasks related to the task of acquiring data and configured to be carried out by discrete interface devices in an absence of information regarding the two or more discrete interface devices operation 504 of FIG. 5.

FIG. 7B is a high-level logic flowchart of a process depicting alternate implementations of an acquiring one or more subtasks related to the task of acquiring data and configured to be carried out by discrete interface devices in an absence of information regarding the two or more discrete interface devices operation 504 of FIG. 5.

FIG. 7C is a high-level logic flowchart of a process depicting alternate implementations of an acquiring one or more subtasks related to the task of acquiring data and configured to be carried out by discrete interface devices in an absence of information regarding the two or more discrete interface devices operation 504 of FIG. 5.

FIG. 8A is a high-level logic flowchart of a process depicting alternate implementations of an obtaining a result of one or more executed subtasks executed by at least two of the discrete interface devices in the absence of information regarding the at least one task and/or the task requestor operation 506 of FIG. 5.

FIG. 8B is a high-level logic flowchart of a process depicting alternate implementations of an obtaining a result of one or more executed subtasks executed by at least two of the discrete interface devices in the absence of information regarding the at least one task and/or the task requestor operation 506 of FIG. 5.

FIG. 8C is a high-level logic flowchart of a process depicting alternate implementations of an obtaining a result of one or more executed subtasks executed by at least two of the discrete interface devices in the absence of information regarding the at least one task and/or the task requestor operation 506 of FIG. 5.

FIG. 8D is a high-level logic flowchart of a process depicting alternate implementations of an obtaining a result of one or more executed subtasks executed by at least two of the discrete interface devices in the absence of information regarding the at least one task and/or the task requestor operation 506 of FIG. 5.

FIG. 8E is a high-level logic flowchart of a process depicting alternate implementations of an obtaining a result of one or more executed subtasks executed by at least two of the discrete interface devices in the absence of information regarding the at least one task and/or the task requestor operation 506 of FIG. 5.

FIG. 8F is a high-level logic flowchart of a process depicting alternate implementations of an obtaining a result of one or more executed subtasks executed by at least two of the discrete interface devices in the absence of information regarding the at least one task and/or the task requestor operation 506 of FIG. 5.

FIG. 8G is a high-level logic flowchart of a process depicting alternate implementations of an obtaining a result of one or more executed subtasks executed by at least two of the discrete interface devices in the absence of information regarding the at least one task and/or the task requestor operation 506 of FIG. 5.

FIG. 8H is a high-level logic flowchart of a process depicting alternate implementations of an obtaining a result of one or more executed subtasks executed by at least two of the discrete interface devices in the absence of information regarding the at least one task and/or the task requestor operation 506 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

In addition, the promulgation of portable electronic devices, each having their own set of unique sensors and detectors, has been widespread. Currently, there are very few populated areas of developed countries that do not contain a large number of portable computing devices at any given time. These portable computing devices are constantly collecting data, and capable of collecting data, which is not stored in any repository or transmitted to any device that may use such data. Thus, such data, and opportunity to collect data, may be lost.

In accordance with various embodiments, computationally implemented methods, systems, and articles of manufacture are provided for receiving a request to carry out a task of acquiring data requested by a task requestor, acquiring one or more subtasks related to the task of acquiring data and configured to be carried out by discrete interface devices in an absence of information regarding the at least one task and/or the task requestor, and obtaining a result of one or more executed subtasks executed by at least two of the discrete interface devices in the absence of information regarding the at least one task and/or the task requestor.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

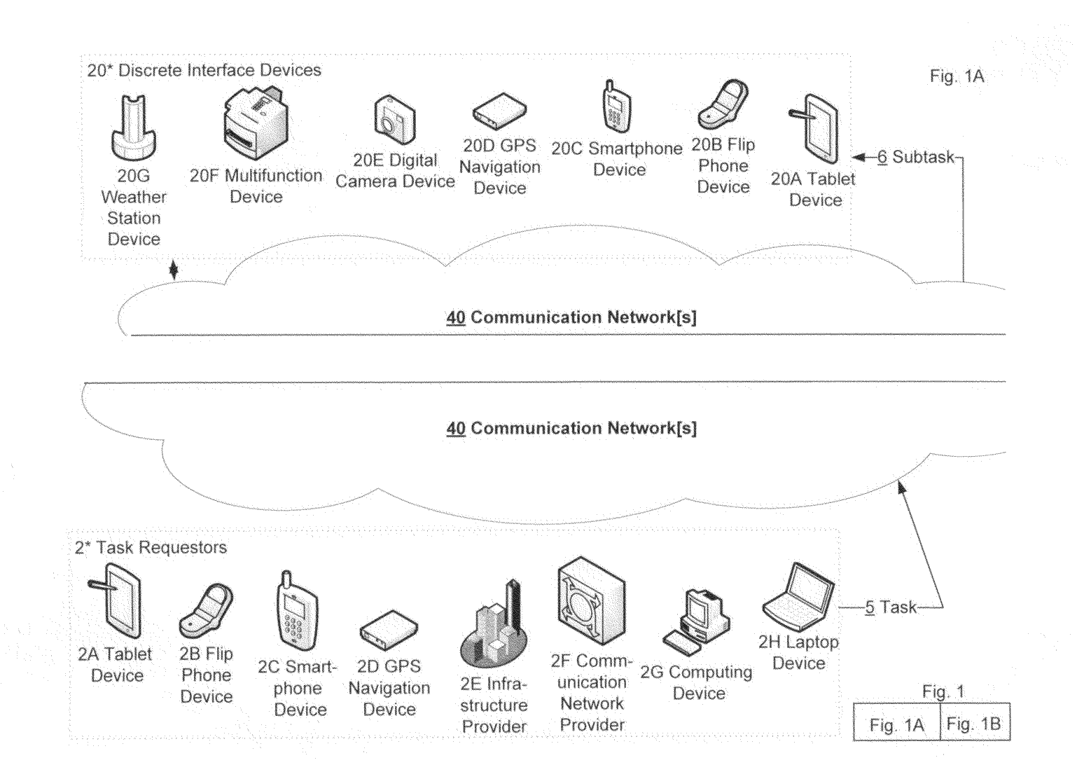

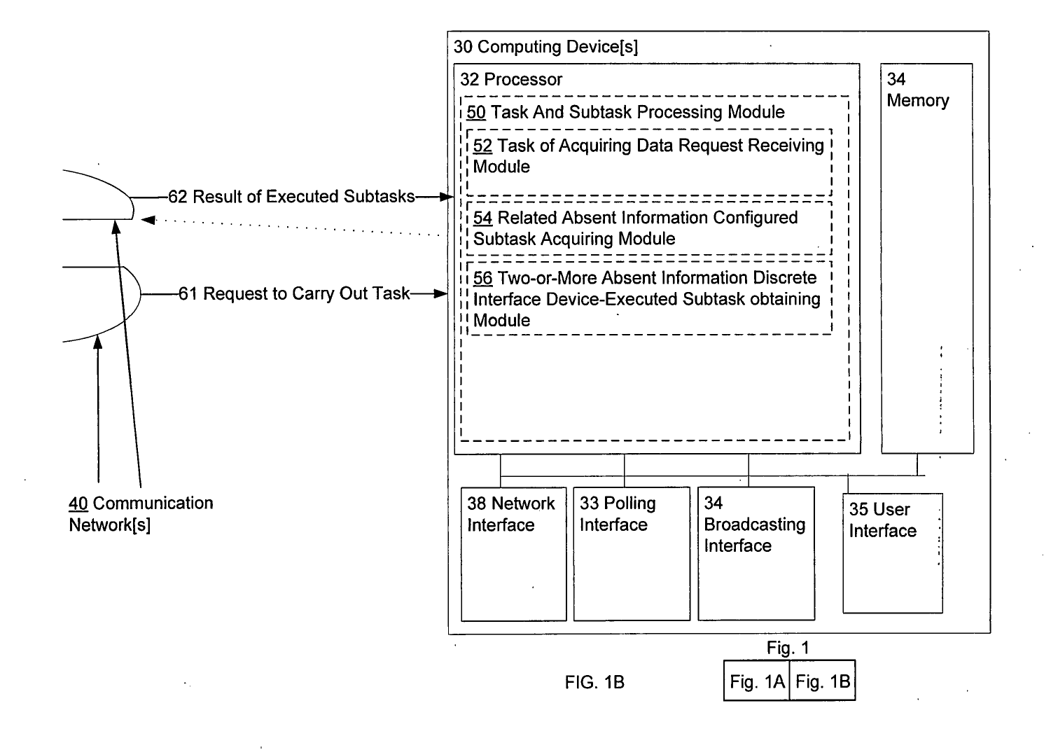

Referring now to FIG. 1, FIG. 1 illustrates a computing device 30 in an exemplary environment 100. As will be described in more detail herein, the computing device 30 may employ the computationally implemented methods, systems, and articles of manufacture in accordance with various embodiments. The computing device 30, in various embodiments, may be endowed with logic that is designed to acquire one or more subtasks that correspond to portions of a task of acquiring data requested by a task requestor, wherein the task of acquiring data is configured to be carried out by two or more discrete interface devices, transmit at least one of the one or more subtasks to at least two of the two or more discrete interface devices, wherein the one or more subtasks are configured to be carried out in an absence of information regarding the task requestor and/or the task of acquiring data, and receive result data corresponding to a result of an executed one or more subtasks

Note that in the following description, the character “*” represents a wildcard. Thus, references to, for example, task requestors 2* of FIG. 1 may be in reference to tablet device 2A, flip phone device 2B, smartphone device 2C, GPS navigation device 2D, infrastructure provider 2E, communication network provider 2F, computing device 2G, laptop device 2H, which may be part of computing device 30, but for the purposes of the interface devices described herein, is not distinguishable from the other task requestors 2*. FIG. 1 illustrates a number of task requestors 2*. For example, FIG. 1 illustrates task requestor 2A as a tablet, task requestor 2B as a flip phone, and task requestor 2C as a smartphone device. These drawings are meant to be illustrative only, and should not be construed as limiting the definition of task requestors 2*, which can be any device with computing functionality.

Similarly, interface devices 20* of FIG. 1 may be in reference to tablet device 20A, flip phone device 20B, smartphone device 20C, GPS navigation device 20D, digital camera device 20E, multifunction device 20F, and weather station device 20G. These drawings are meant to be illustrative only, and should not be construed as limiting the definition of interface devices 20*, which can be any device with computing functionality.

Within the context of this application, “discrete interface device” is defined as an “interface device capable of operating or being operated independently of other discrete interface devices.” The discrete interface devices may be completely unaware of each other, and are not necessarily the same type. For example, discrete interface devices 20*, which will be described in more detail herein, include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

Referring again to the exemplary environment 100 of FIG. 1, in various embodiments, the task requestors 2 may send a task, e.g., task 5 to computing device 30. Computing device 30 may be any type of device that has a processor and may communicate with other devices. Although FIG. 1 illustrates computing device 30 as a single unit, computing device 30 may be implemented as multiple computers, servers, or other devices, operating singularly or in parallel, connected locally or via any type of network. As shown in FIG. 1, computing device 30 is illustrated as having several modules that will be discussed in more detail herein. Specifically, these particular modules may be implemented across different networks and systems, and may be partially or wholly unaware of each other, except for the need to transmit data as indicated by the arrows within computing device 30.

A task 5 sent from a task requestor 2* may be received by computing device 30, and separated into its component subtasks. In other embodiments, a task 5 sent from a task requestor 2* may be received by another computing device (not shown), and separated into its component subtasks, which then may be sent to computing device 30. In some embodiments, the another computing device may rely on partial human intervention to be separated into its component subtasks. In other embodiments, the another computing device may be entirely automated, and may use such techniques as are known in the art to separate tasks into subtasks. Tasks may be separated into component subtasks using any known type of processing, including neural net processing, natural language processing, machine learning, logic-based processing, and knowledge-based processing. For example, a received task may be “Take a 360 degree picture of the Eiffel Tower.” The subtask acquiring module 32 may process the language of this received task, and separate it into components of “take a picture of the Eiffel Tower.” Either by consulting machine archives or by predicting how many pictures must be combined to make a 360 degree picture, the system may determine, for example, that 25 pictures of the Eiffel Tower are needed. These twenty-five “take a picture of the Eiffel Tower” subtasks thus are created. The preceding example is merely a simple example of how a computing device 30 may process tasks into subtasks. Other methods, which may be substantially more complex, may be used in this process, but are not discussed in detail here.

The computing device 30 may communicate via a communications network 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to communication networks, which may or may not interact with each other. It is further noted, that, in this drawing, communication network 40 is shown having a split between the task requestors 2* and the discrete interface devices 20*. This is because, in embodiments, the discrete interface devices 20* cannot communicate with the task requestors 2*. As will be discussed in more detail herein, the discrete interface devices 20* operate with a smaller subset of information than what is available to task requestors 2* regarding the nature of the task and/or the task requestor, e.g., discrete interface devices 20* operate in an “absence of information regarding the task and/or the task requestor.”

Computing device 30 may include a network interface module 38 to facilitate communications with communications network 40. Network interface module 38, which may be implemented as hardware or software, or both, used to interface the computing device 30 with the one or more communication networks 40. In some embodiments, the network interface module 38 may be a Network Interface Card, e.g., a NIC, or an antenna. The specific structure of network interface module 38 depends on the type or types of one or more communication networks 40 that are used. Particular details of this transmission will be discussed in more detail herein.

Computing device 30 also may include a polling interface 33 and a broadcasting interface 34, which also may interface with communications network 40. Polling interface 33 and broadcasting interface 34 also may be implemented as hardware or software, or both, and may share component parts and/or machine-readable instructions with network interface module 38. In some embodiments, the same hardware and/or software is used to implement network interface 38, polling interface 33, and broadcasting interface 34. The specific functions of these devices will be discussed in more detail herein with respect to the modules and computationally-implemented methods described herein.

As shown in FIG. 1, computing device 30 may receive a request to acquire data 61, e.g., a request for a task. This request may come either directly from the task requestors 2* or from another computing device (not shown) that collects and/or processes the tasks received from task requestors 2*.

Further, as shown in FIG. 1, computing device 30 may obtain a result of one or more executed subtasks 62. In some, but not all, instances, computing device 30 may transmit the acquired subtasks to the discrete interface devices 20*, either directly or indirectly (shown as un-numbered dotted line).

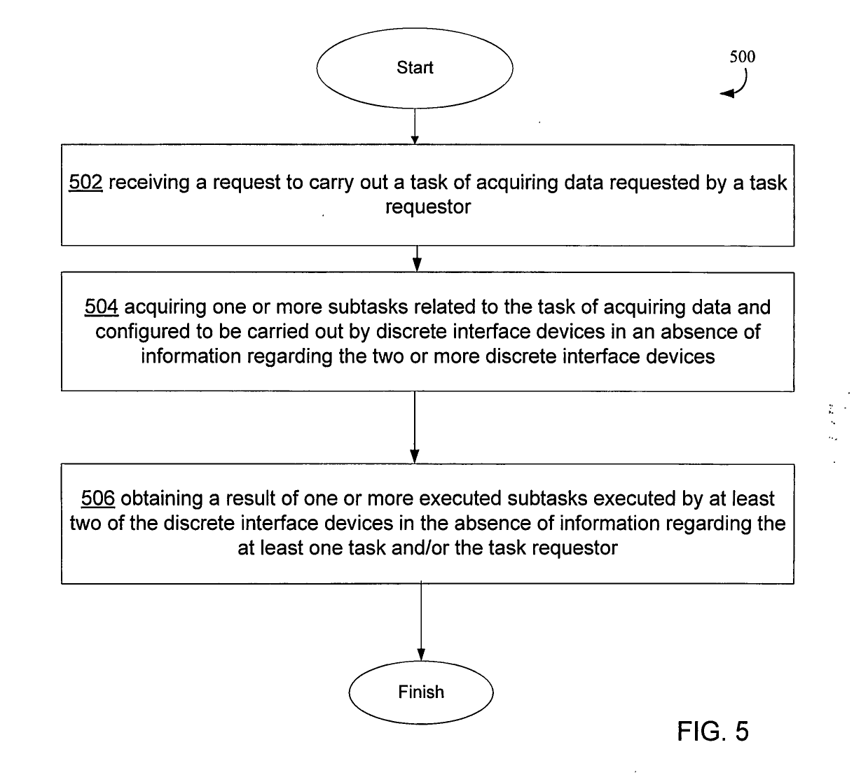

Referring again to the example environment 100 of FIG. 1, in various embodiments, the computing device 30 may comprise, among other elements, a processor 32, a memory 34, and a user interface 35. Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 5A-5C, 6A-6E, and 7A-7G. In some embodiments, processor 32 is designed to be configured to operate as the subtask module 50, which may include task portion two-or-more discrete interface device subtask acquiring module 52, absent knowledge of task and/or task requestor information subtask transmitting module 54, and executed subtask result data receiving module 56.

As described above, the computing device 30 may comprise a memory 34. In some embodiments, memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 34 may be located at multiple network sites, including sites that are distant from each other.

As described above, and with reference to FIG. 1, computing device 30 may include a user interface 35. The user interface may be implemented in hardware or software, or both, and may include various input and output devices to allow an operator of a computing device 30 to interact with computing device 30. For example, user interface 35 may include, but is not limited to, an audio display, a video display, a microphone, a camera, a keyboard, a mouse, a joystick, a game controller, a touchpad, a handset, or any other device that allows interaction between a computing device and a user.

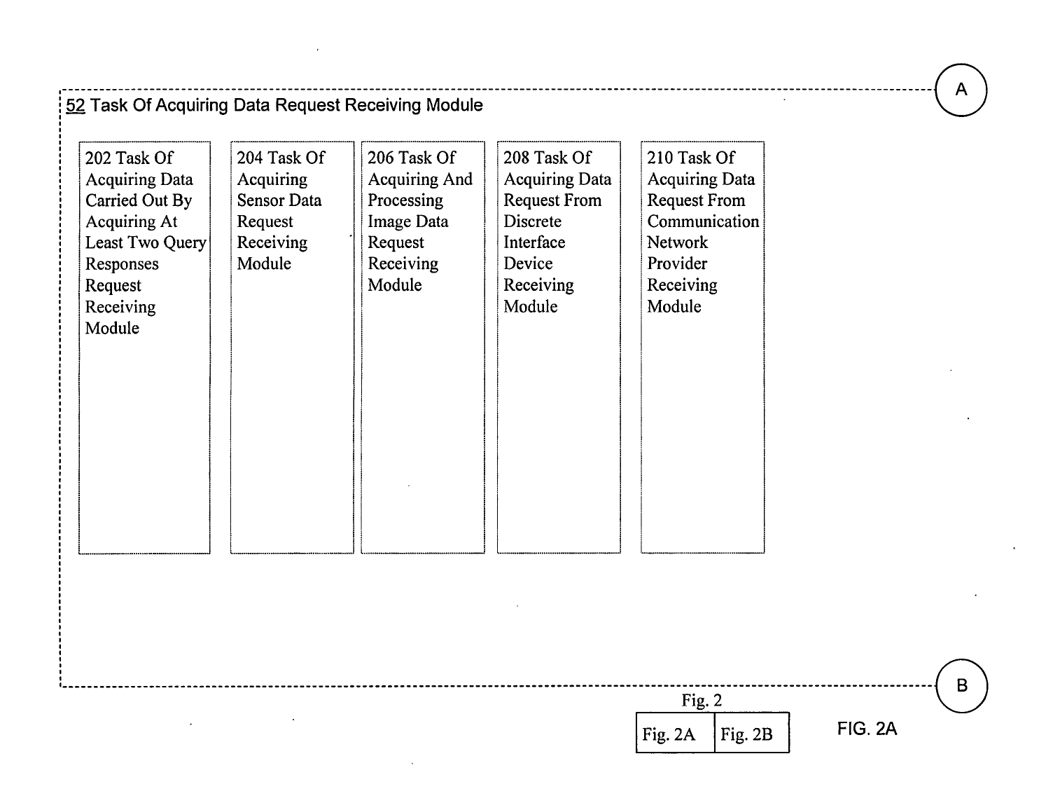

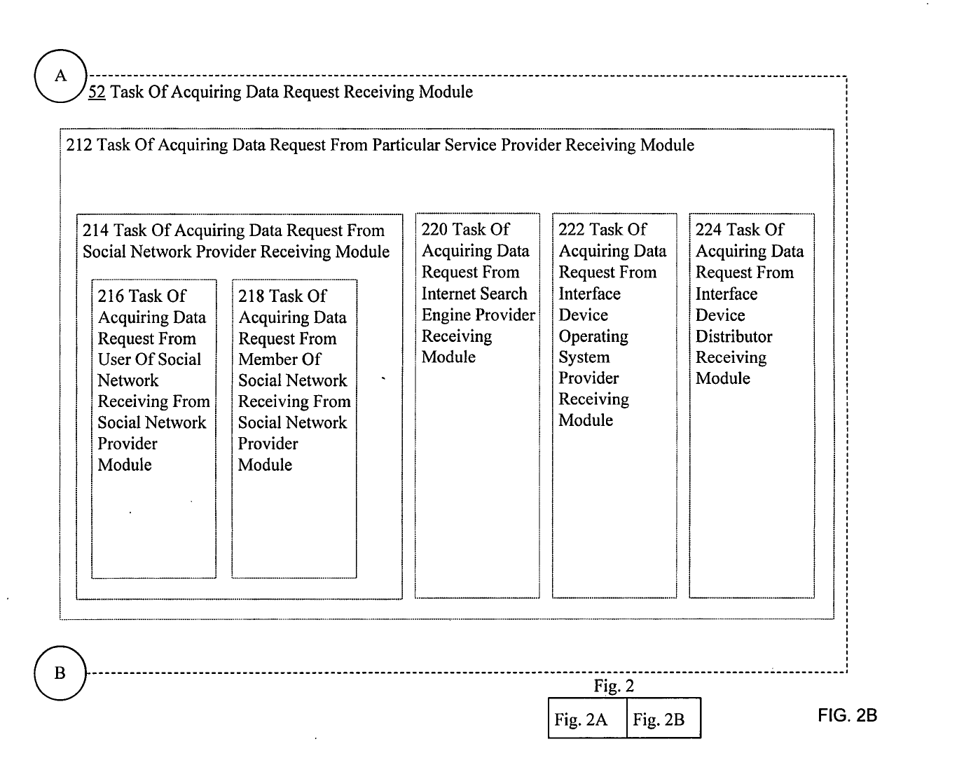

Referring now to FIG. 2, FIG. 2 illustrates an exemplary implementation of the task of acquiring data request receiving module 52 of the module 50. As illustrated in FIG. 2A, the task of acquiring data request receiving module 52 may include one or more sub-logic modules in various alternative implementations and embodiments. For example, in some embodiments, module 52 may include task of acquiring data carried out by acquiring at least two query responses request receiving module 202, task of acquiring sensor data request receiving module 204, task of acquiring and processing image data request receiving module 206, task of acquiring data request from discrete interface device receiving module 208, and task of acquiring data request from communication network provider receiving module 210.

As shown in FIG. 2, in some embodiments, module 52 may include task of acquiring data request from particular service provider receiving module 212. Module 212 may include task of acquiring data request from social network provider receiving module 214 (e.g., which, in some embodiments, may include task of acquiring data request from user of social network receiving from social network provider module 216 and task of acquiring data request from member of social network receiving from social network provider module 218), task of acquiring data request from interne search engine provider receiving module 220, task of acquiring data request from interface device operation system provider receiving module 222, and task of acquiring data request from interface device distributor receiving module 224.

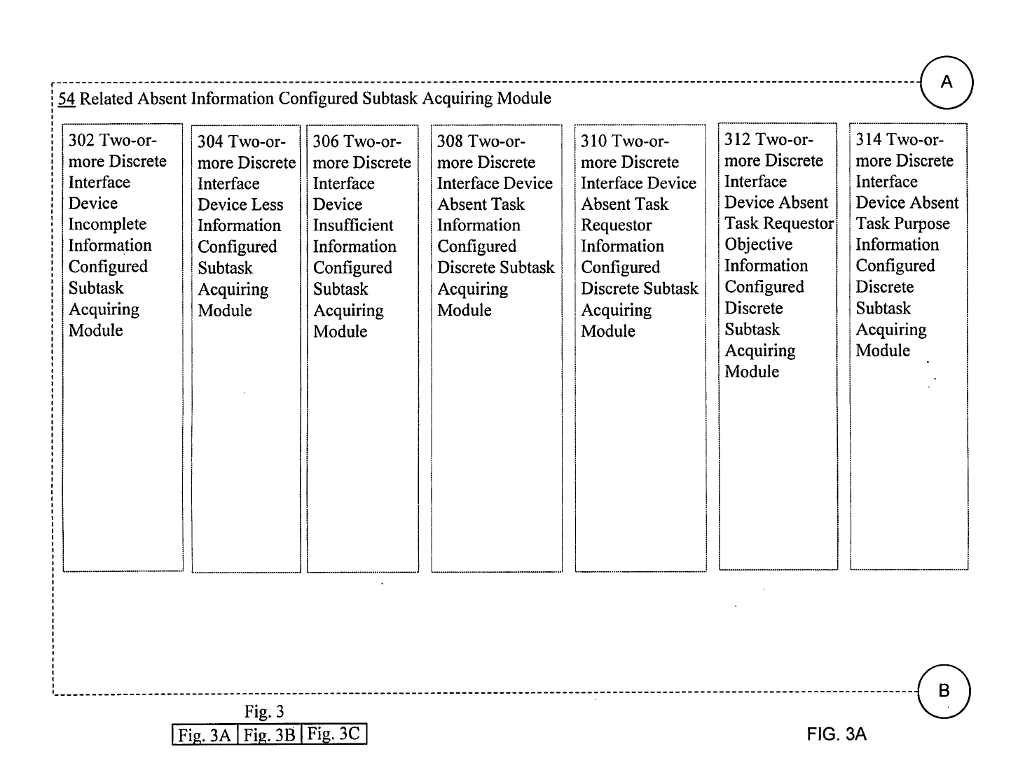

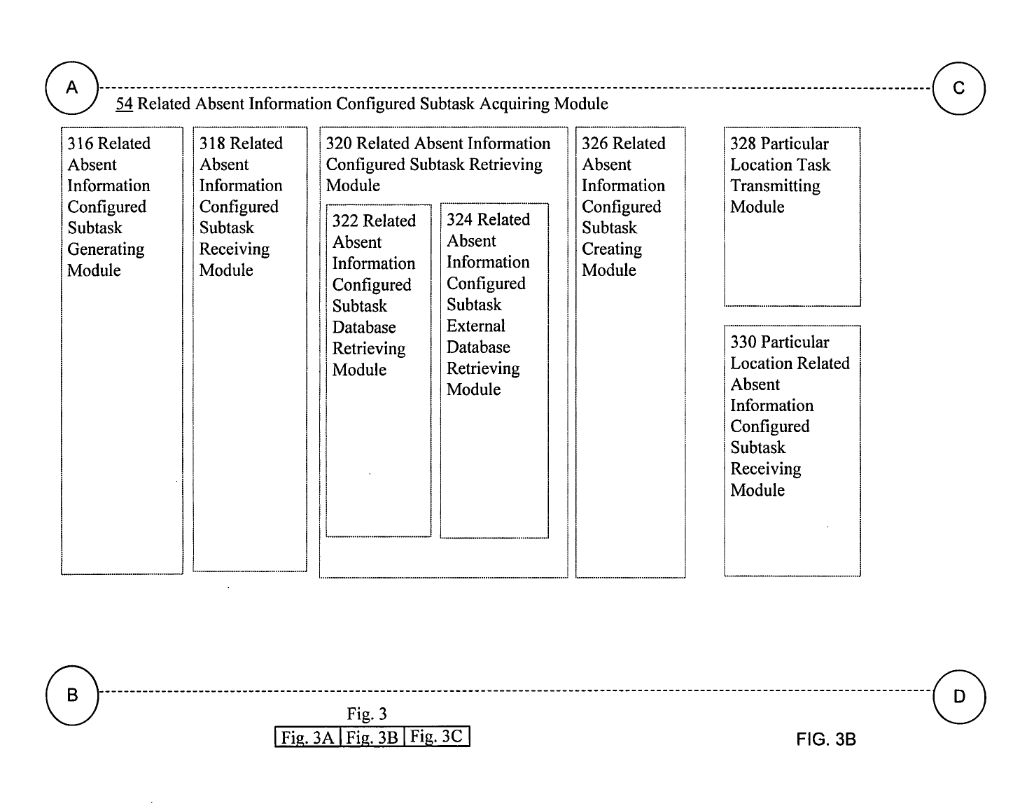

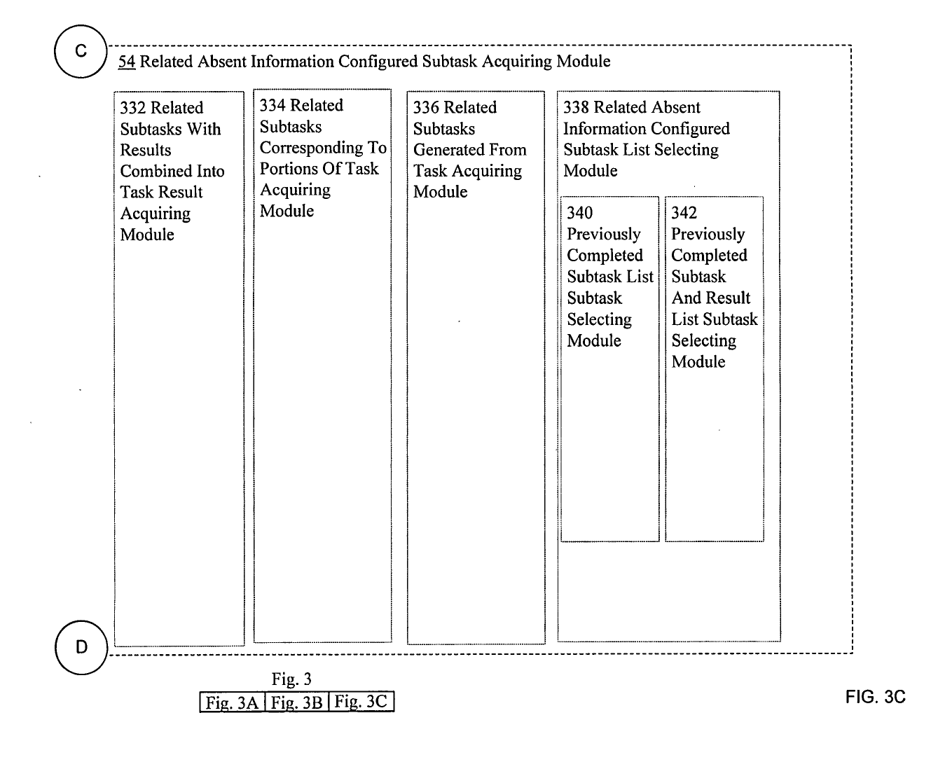

Referring now to FIG. 3, FIG. 3 illustrates an exemplary implementation of the related absent information configured subtask acquiring module 54 of the module 50. As illustrated in FIG. 3, in some embodiments, module 54 may include two-or-more discrete interface device incomplete information configured subtask acquiring module 302, two-or-more discrete interface device less information configured subtask acquiring module 304, two-or-more discrete interface device insufficient information configured subtask acquiring module 306, two-or-more discrete interface device absent task information configured discrete subtask acquiring module 308, two-or-more discrete interface device absent task requestor information configured discrete subtask acquiring module 310, two-or-more discrete interface device absent task requestor objective information configured discrete subtask acquiring module 312, and two-or-more discrete interface device absent task purpose information configured discrete subtask acquiring module 314.

As illustrated in FIG. 3, in some embodiments, module 54 may include related absent information configured subtask generating module 316, related absent information configured subtask receiving module 318, related absent information configured subtask retrieving module 320 (e.g., which, in some embodiments, may include related absent information configured subtask database retrieving module 322 and related absent information configured subtask external database retrieving module 324), related absent information configured subtask creating module 326, particular location task transmitting module 328, and particular location related absent information configured subtask receiving module 330.

As illustrated in FIG. 3, in some embodiments, module 54 may include related subtasks with results combined into task result acquiring module 332, related subtasks corresponding to portions of task acquiring module 334, related subtasks generated from task acquiring module 336, and related absent information configured subtask list selecting module 338 (e.g., which, in some embodiments, may include previously completed subtask list subtask selecting module 340 and previously completed subtask and result list subtask selecting module 342).

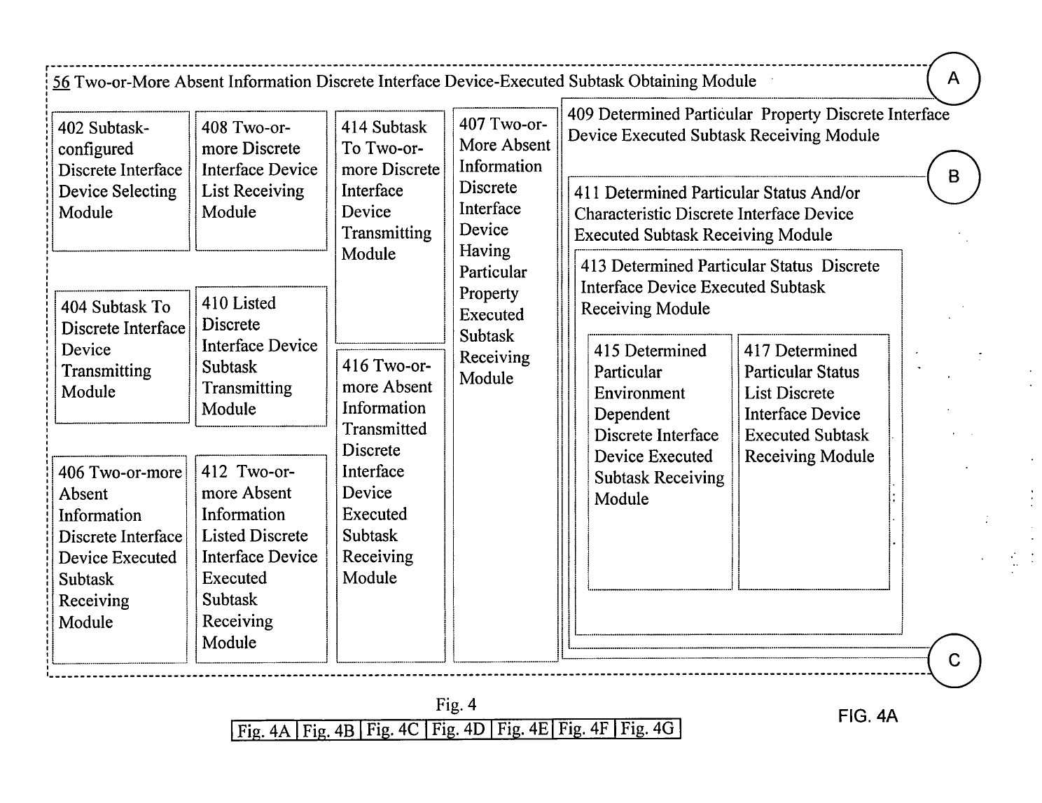

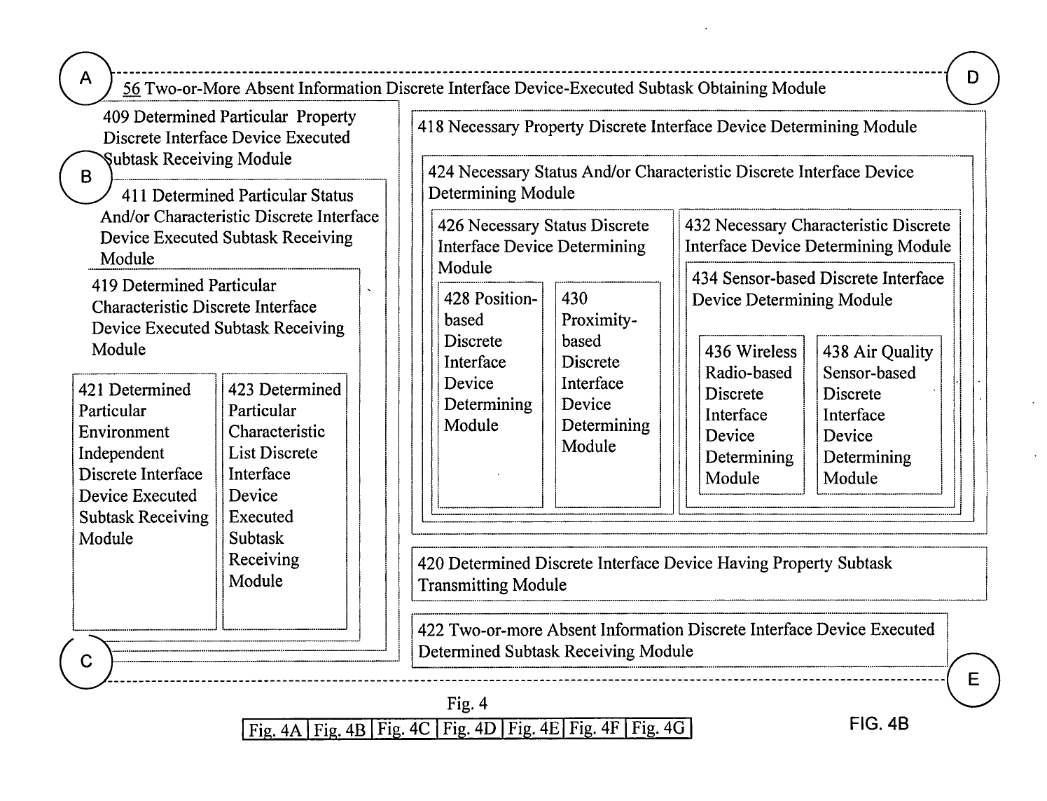

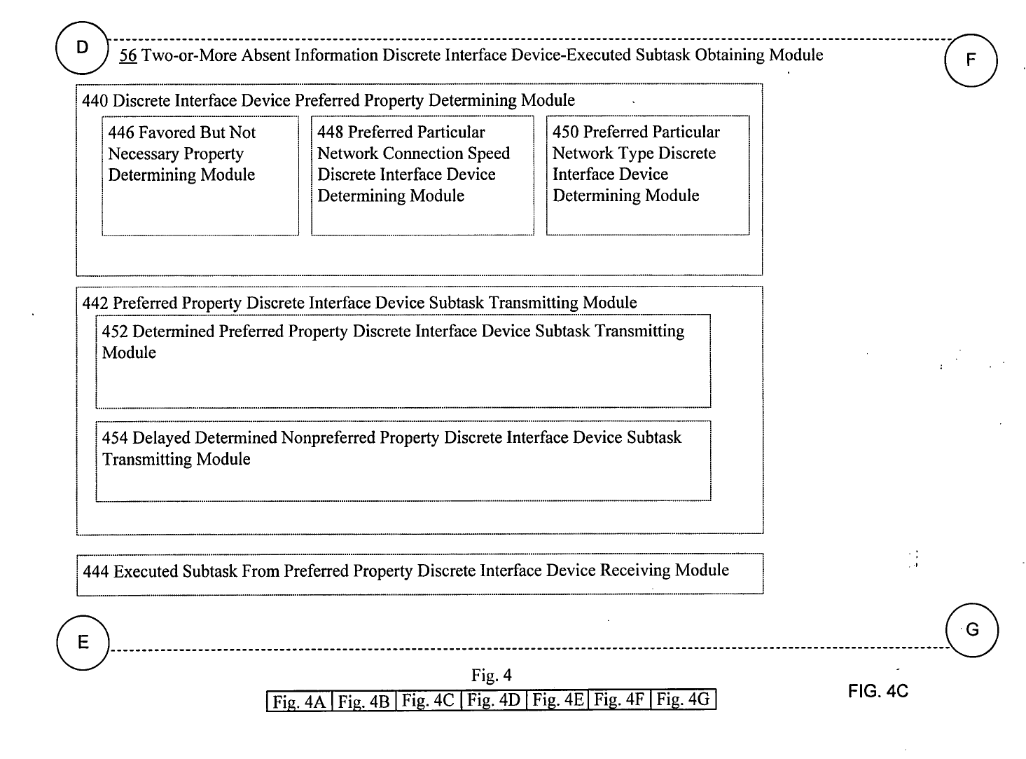

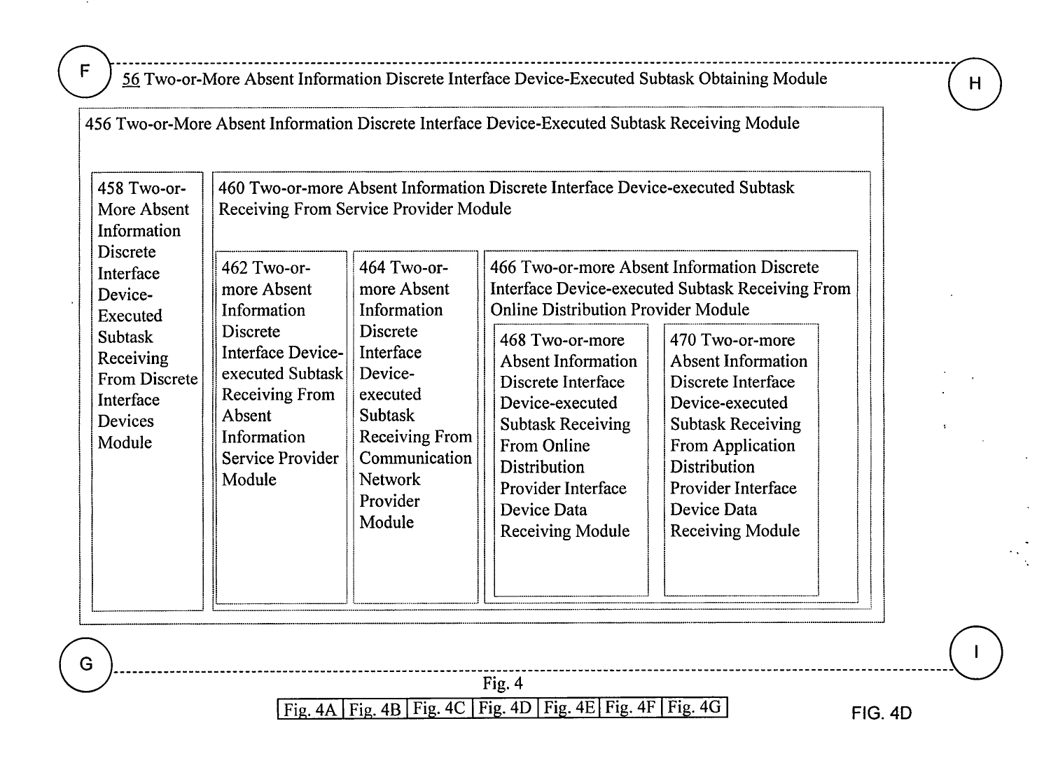

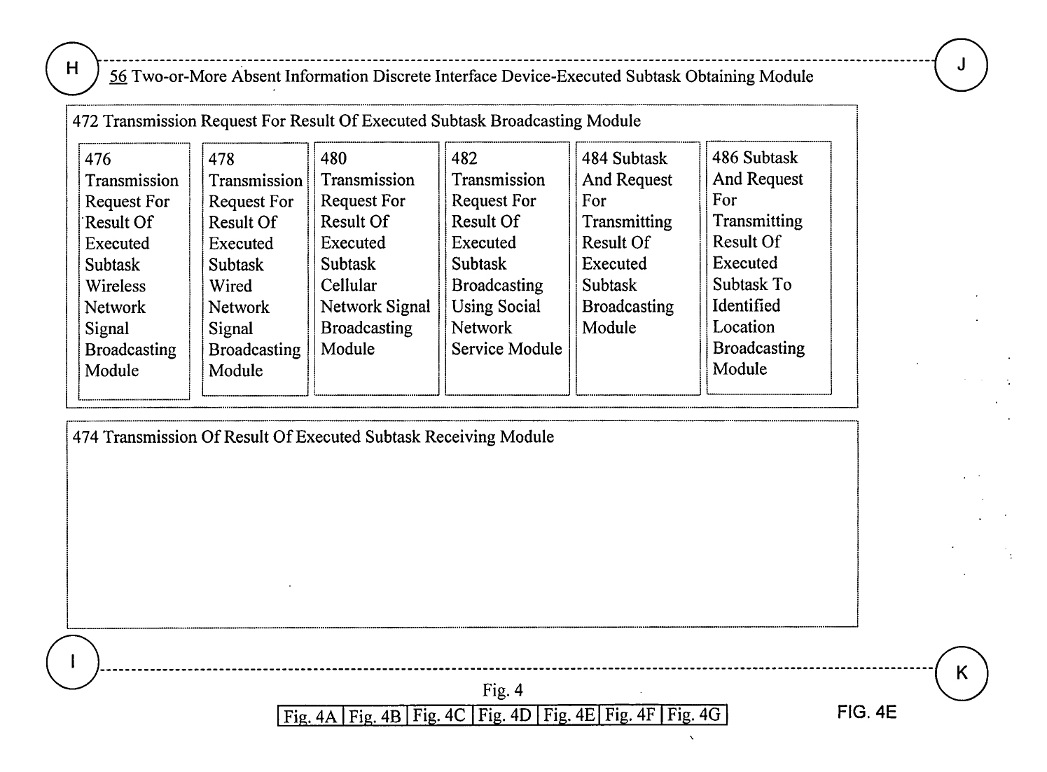

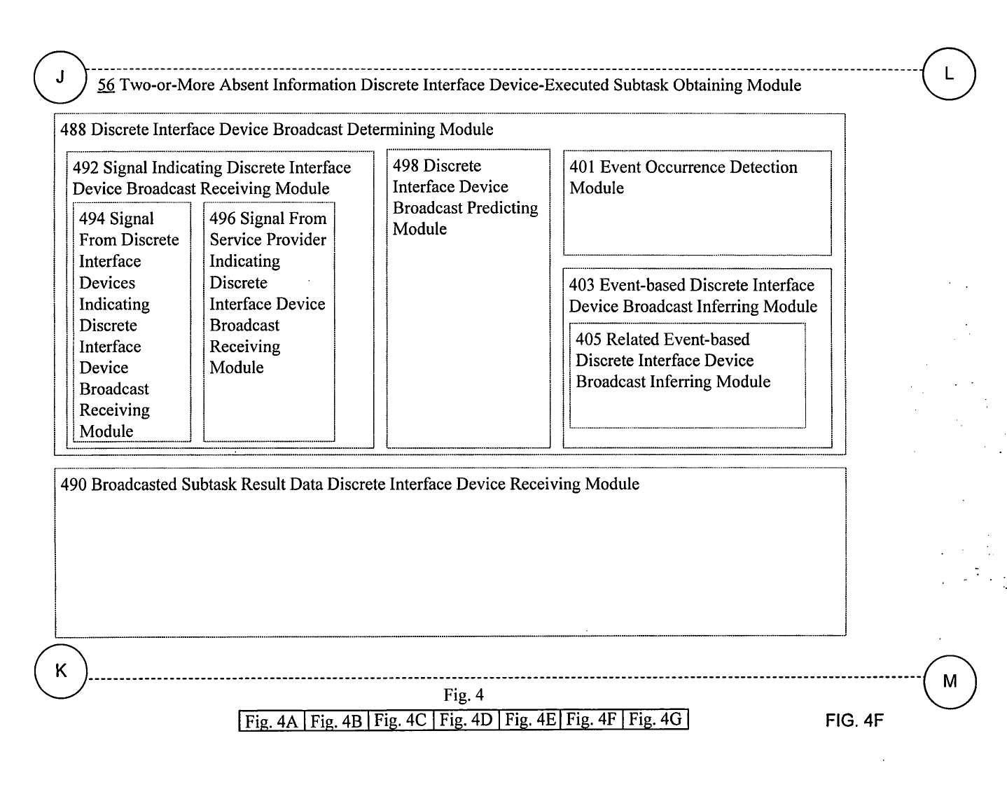

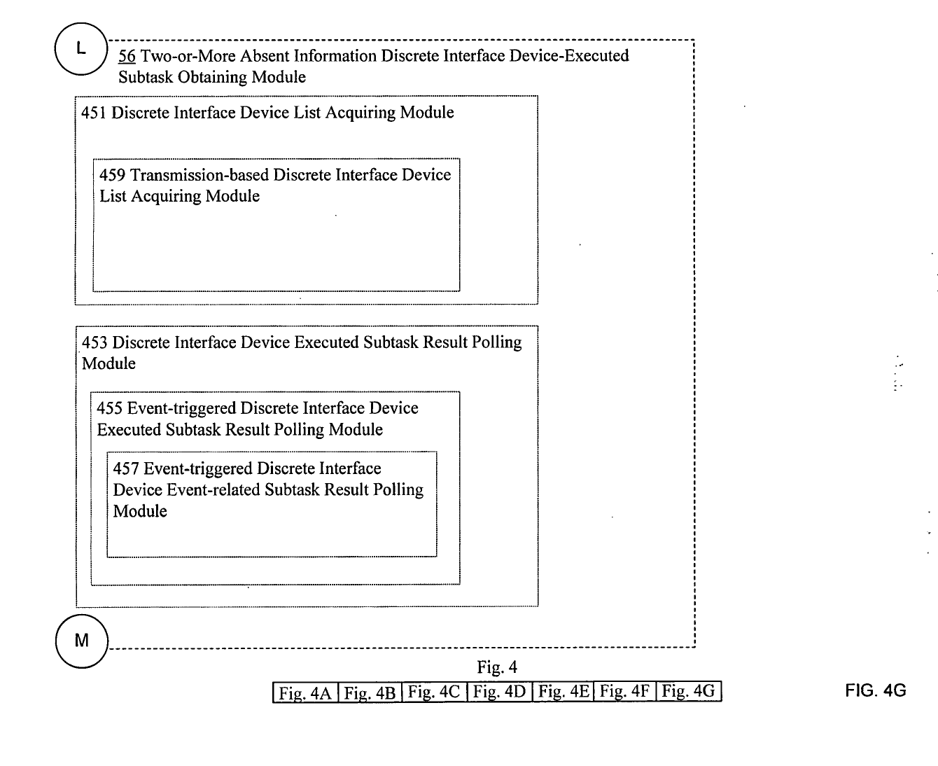

Referring now to FIG. 4, FIG. 4 illustrates an exemplary implementation of the Two-or-More Absent Information Discrete Interface Device-Executed Subtask Obtaining Module 56 of the module 50. As illustrated in FIG. 4, in some embodiments, module 56 may include subtask-configured discrete interface device selecting module 402, subtask to discrete interface device transmitting module 404, two-or-more absent information discrete interface device executed subtask receiving module 406, two-or-more discrete interface device list receiving module 408, listed discrete interface device subtask transmitting module 410, two-or-more absent information listed discrete interface device executed subtask receiving module 412, subtask to two-or-more discrete interface device transmitting module 414, two-or-more absent information transmitted discrete interface device executed subtask receiving module 416, two-or-more absent information discrete interface device having particular property executed subtask receiving module 407, and determined particular property discrete interface device executed subtask receiving module 409. In some embodiments, module 409 may include determined particular status and/or characteristic discrete interface device executed subtask receiving module 411. In some embodiments, module 411 may include determined particular status discrete interface device executed subtask receiving module 413 (e.g., which, in some embodiments, may include determined particular environment dependent discrete interface device executed subtask receiving module 415 and determined particular status list discrete interface device executed subtask receiving module 417)

In some embodiments, module 411 may include determined particular characteristic discrete interface device executed subtask receiving module 419 (e.g., which, in some embodiments, may include determined particular environment independent discrete interface device executed subtask receiving module 421 and determined particular characteristic list discrete interface device executed subtask receiving module 423. In some embodiments, module 56 may include necessary property discrete interface device determining module 418. In some embodiments, module 418 may include necessary status and/or characteristic discrete interface device determining module 424. In some embodiments, module 424 may include necessary status discrete interface device determining module 426 (e.g., which, in some embodiments, may include position-based discrete interface device determining module 428 and proximity-based discrete interface device determining module 430) and necessary characteristic discrete interface device determining module 432. Module 432 may include sensor-based discrete interface device determining module 434 (e.g., which, in some embodiments, may include wireless radio-based discrete interface device determining module 436 and air quality sensor-based discrete interface device determining module 438). Module 56 also may include determined discrete interface device having property subtask transmitting module 420 and two-or-more absent information discrete interface device executed determined subtask receiving module 422.

In some embodiments, module 56 may include discrete interface device preferred property determining module 440 (e.g., which, in some embodiments, may include favored but not necessary property determining module 446, preferred particular network connection speed discrete interface device determining module 448, and preferred particular network type discrete interface device determining module 450), preferred property discrete interface device subtask transmitting module 442 (e.g., which, in some embodiments, may include determined preferred property discrete interface device subtask transmitting module 452 and delayed determined nonpreferred property discrete interface device subtask transmitting module 454), and executed subtask from preferred property discrete interface device receiving module.

In some embodiments, module 56 may include two-or-more absent information discrete interface device-executed subtask receiving module 456. Module 456 may include two-or-more absent information discrete interface device-executed subtask receiving from discrete interface devices module 458 and two-or-more absent information discrete interface device-executed subtask receiving from service provider module 460 (e.g., which, in some embodiments, may include two-or-more absent information discrete interface device-executed subtask receiving from absent information service provider module 462, two-or-more absent information discrete interface device-executed subtask receiving from communication network provider module 464, and two-or-more absent information discrete interface device-executed subtask receiving from online distribution provider module 466 (e.g., which, in some embodiments, may include two-or-more absent information discrete interface device-executed subtask receiving from online distribution provider interface device data receiving module 468 and two-or-more absent information discrete interface device-executed subtask receiving from application distribution provider interface device data receiving module 470)).

In some embodiments, module 56 may include transmission request for result of executed subtask broadcasting module (e.g., which, in some embodiments, may include transmission request for result of executed subtask wireless network signal broadcasting module 476, transmission request for result of executed subtask wired network signal broadcasting module 478, transmission request for result of executed subtask cellular network signal broadcasting module 480, transmission request for result of executed subtask broadcasting using social network service module 482, subtask and request for transmitting result of executed subtask broadcasting module 484, and subtask and request for transmitting result of executed subtask to identified location broadcasting module 486), and transmission of result of executed subtask receiving module 474.

In some embodiments, module 56 may include discrete interface device broadcast determining module 488 and broadcasted subtask result data discrete interface device receiving module 490. In some embodiments, module 488 may include signal indicating discrete interface device broadcast receiving module 492 (e.g., which, in some embodiments, may include signal from discrete interface devices indicating discrete interface device broadcast receiving module 494 and signal from service provider indicating discrete interface device broadcast receiving module 496), discrete interface device broadcast predicting module 498, event occurrence detection module 401, event-based discrete interface device broadcast inferring module 403 (e.g., which, in some embodiments, may include related event-based discrete interface device broadcast inferring module 405).

In some embodiments, module 56 may include discrete interface device list acquiring module 451 (e.g., which, in some embodiments, may include transmission-based discrete interface device list acquiring module 459) and discrete interface device executed subtask result polling module 453 (e.g., which, in some embodiments may include event-triggered discrete interface device executed subtask result polling module 455 (e.g., which, in some embodiments, may include event-triggered discrete interface device event-related subtask result polling module 457.

A more detailed discussion related to computing device 30 of FIG. 1 now will be provided with respect to the processes and operations to be described herein. Referring now to FIG. 5, FIG. 5 illustrates an operational flow 500 representing example operations for, among other methods, receiving a request to carry out a task of acquiring data requested by a task requestor, acquiring one or more subtasks related to the task of acquiring data and configured to be carried out by discrete interface devices in an absence of information regarding the at least one task and/or the task requestor, and obtaining a result of one or more executed subtasks executed by at least two of the discrete interface devices in the absence of information regarding the at least one task and/or the task requestor.

In FIG. 5 and in the following figures that include various examples of operational flows, discussions and explanations will be provided with respect to the exemplary environment 100 as described above and as illustrated in FIG. 1, and with respect to other examples (e.g., as provided in FIGS. 2-4) and contexts. It should be understood that the operational flows may be executed in a number of other environments and contexts, and/or in modified versions of the systems shown in FIGS. 2-4. Although the various operational flows are presented in the sequence(s) illustrated, it should be understood that the various operations may be performed in other orders other than those which are illustrated, or may be performed concurrently.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 4 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 4 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Referring again to FIG. 5, FIG. 5 shows operation 500 that may include operation 502 depicting receiving a request to carry out a task of acquiring data requested by a task requestor. For example, FIG. 1 shows a task of acquiring data request receiving module 52 receiving a request to carry out a task of acquiring data (e.g., “take a 360-degree picture of Times Square at midnight”) requested by a task requestor (e.g., a person operating an interface device, an interface device, a machine requesting information, a provider of services, e.g., social networking services or communication network services, wireless or cellular network services), or some combination.

Referring again to FIG. 5, FIG. 5 shows operation 500 that may include operation 504 depicting acquiring one or more subtasks related to the task of acquiring data and configured to be carried out by discrete interface devices in an absence of information regarding the at least one task and/or the task requestor. For example, FIG. 1 shows a related absent information configured subtask acquiring module 54 acquiring one or more subtasks (e.g., “activate an image capturing sensor when the image capturing sensor is pointed toward Times Square”) related to the task of acquiring data (e.g., “take a 360-degree picture of Times Square at midnight”) and configured to be carried out by discrete interface devices (e.g., devices with a camera, e.g., an Apple iPhone 4, and a Samsung Galaxy Tablet) in an absence of information regarding the task and/or the task requestor (e.g., the two or more discrete interface devices carry out the subtask with an absence of (e.g., less, incomplete, missing, or withheld) information regarding at least one of the task and the task requestor).

Referring again to FIG. 5, FIG. 5 shows operation 500 that may include operation 506 depicting obtaining a result of one or more executed subtasks executed by at least two of the discrete interface devices in the absence of information regarding the at least one task and/or the task requestor. For example, FIG. 1 shows a two-or-more absent information discrete interface device-executed subtask obtaining module 56 obtaining a result (e.g., receiving a result) of one or more executed subtasks (e.g., “activate an image capturing sensor when the image capturing sensor is pointed toward Times Square”) executed by at least two of the discrete interface devices (e.g., Apple iPhone 4, and a Samsung Galaxy Tablet) in the absence of information regarding the at least one task and/or the task requestor (e.g., the two or more discrete interface devices carry out the subtask with an absence of (e.g., less, incomplete, missing, or withheld) information regarding at least one of the task and the task requestor).

It is noted that “in an absence of information” does not imply a complete absence of information, but rather that the interface devices carrying out the subtasks have a smaller subset of information than a single device carrying out the task of acquiring data would have. In some instances, a sufficiently advanced interface device could infer the task of acquiring data, or guess the task of acquiring data, but the interface device would still be operating in an “absence of information” as defined in the claims. It is not necessary for the interface device to operate in a complete lack of information regarding the task and/or the task requestor to operate in an absence of information. Some exemplary “absence of information” scenarios will be discussed in more detail herein. These examples are not intended to be exhaustive but rather to illustrate examples of scenarios that present an “absence of information.”

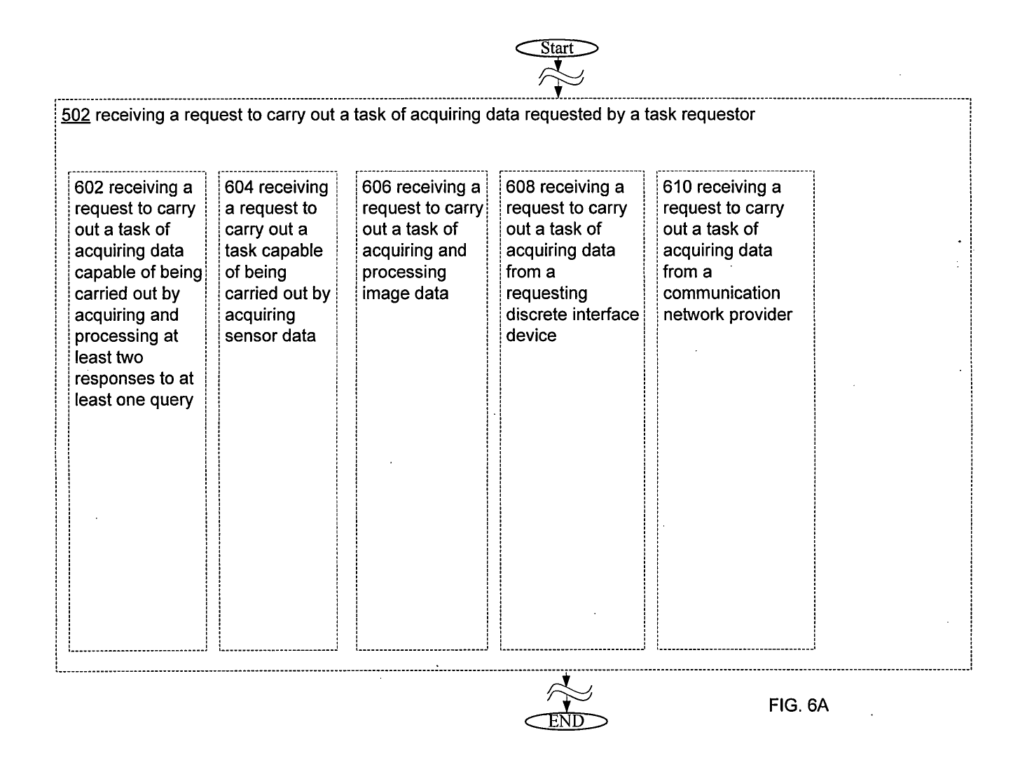

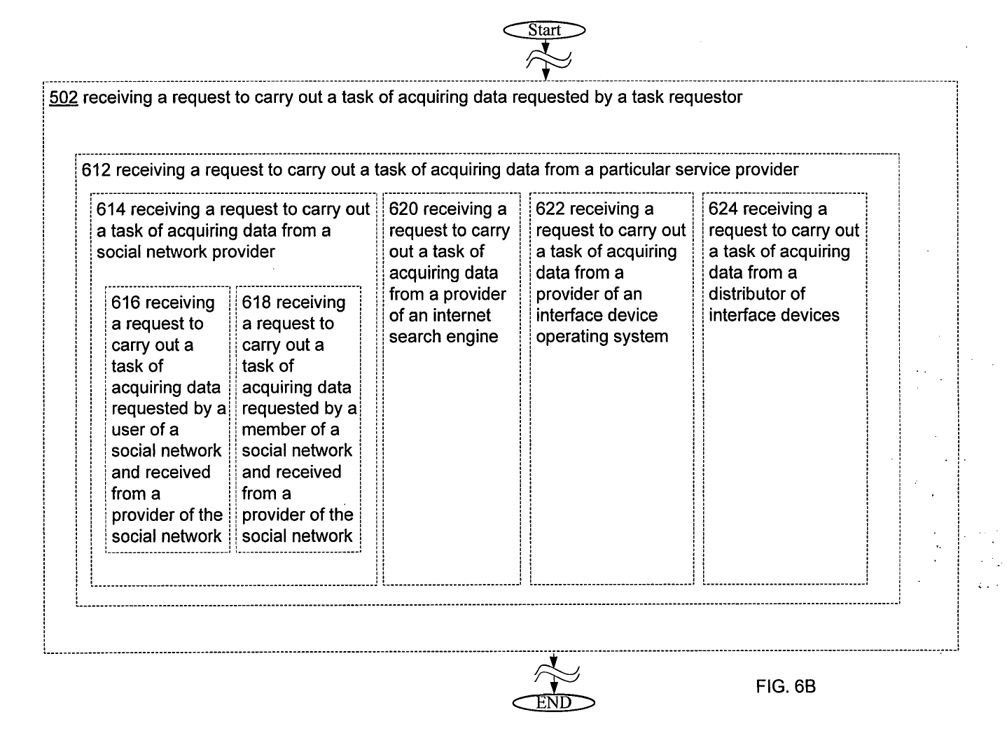

FIGS. 6A-6B depict various implementations of operation 502, according to embodiments. Referring now to FIG. 6, operation 502 may include operation 602 depicting receiving a request to carry out a task of acquiring data capable of being carried out by receiving at least two responses to at least one query. For example, FIG. 2 shows task of acquiring data carried out by acquiring at least two query responses request receiving module 202 receiving a request to carry out a task of acquiring data (e.g., “determine which bagel shop in Old Town Alexandria has the freshest bagels”) capable of being carried out by acquiring and processing at least two responses to at least one query (e.g., “how fresh is the bagel you bought at your current location,” sent to at least two people determined to be located in bagel shops).

Referring again to FIG. 6A, operation 502 may include operation 604 depicting receiving a request to carry out a task capable of being carried out by acquiring sensor data. For example, FIG. 2 shows task of acquiring sensor data request receiving module 204 receiving a request to carry out a task of acquiring data (e.g., “take a 360 degree near-real time picture of Times Square”) capable of being carried out by acquiring sensor data (e.g., capturing images from 50 interface devices being used at times square currently, and stitching the photographs together into a 360 degree near-real time picture).

Referring again to FIG. 6A, operation 502 may include operation 606 depicting receiving a request to carry out a task of acquiring and processing image data. For example, FIG. 2 shows task of acquiring and processing image data request receiving module 206 receiving a request to carry out a task (e.g., determine which seat at Merriweather Post Pavillion has an unobstructed view of the stage set up for the U2 concert) of acquiring (e.g., receiving the image data from multiple interface devices determined to be located at various parts of the Merriweather Post Pavillion) and processing (e.g., determining which images represent an unobstructed view of the stage) image data.

Referring again to FIG. 6A, operation 502 may include operation 608 depicting receiving a request to carry out a task of acquiring data from a requesting discrete interface device. For example, FIG. 2 shows task of acquiring data request from discrete interface device receiving module 208 receiving a request to carry out a task of acquiring data (e.g., “determine how bad traffic is on the south branch of I-495”) from a requesting discrete interface device (e.g., a Blackberry of a user on the western portion of I-495, trying to determine whether to detour off of the road or stay on to arrive at the south branch, who sends a request for a task of acquiring data).

Referring again to FIG. 6A, operation 502 may include operation 610 depicting receiving a request to carry out a task of acquiring data requested by a communication network provider. For example, FIG. 2 shows task of acquiring data request from communication network provider receiving module 210 receiving a request to carry out a task of acquiring data (e.g., “determine which parts of Clarendon, Va. have the fastest 4G upload speeds”) from a communication network provider (e.g., Verizon Wireless, which provides the 4G LTE network in certain areas of the United States).

Referring now to FIG. 6B, operation 502 may include operation 612 depicting receiving a request to carry out a task of acquiring data requested by a particular service provider. For example, FIG. 2 shows task of acquiring data request from particular service provider receiving module 212 receiving a request to carry out a task of acquiring data (e.g., “determine how many people are going to the Nationals game tonight to watch Stephen Strasburg pitch”) requested by a particular service provider (e.g., Facebook).

Referring again to FIG. 6B, operation 612 may include operation 614 depicting receiving a request to carry out a task of acquiring data requested by a social network provider. For example, FIG. 2 shows task of acquiring data request from social network provider receiving module 214 receiving a request to carry out a task of acquiring data (e.g., “determine how many people currently located in the DuPont Circle area of Washington, D.C. have tickets to see the band Dogsprot on December 22”) from a social network provider (e.g., MySpace).

Referring again to FIG. 6B, operation 614 may include operation 616 depicting receiving a request to carry out a task of acquiring data requested by a user of a social network and received from a provider of the social network. For example, FIG. 2 shows task of acquiring data request from user of social network receiving from social network provider module 216 receiving a request to carry out a task of acquiring data (e.g., “determine which seats at Merriweather Post Pavillion are shielded from viewing by people in the top deck”) requested by a user of a social network (e.g., a person who is a user of Facebook makes a request that is transmitted to Facebook's servers) and received from a provider of the social network (e.g., Facebook actually sends the request to carry out a task of acquiring data even though the task requestor is the discrete interface device on which the user sent the request to Facebook).

Referring again to FIG. 6B, operation 614 may include operation 618 depicting receiving a request to carry out a task of acquiring data requested by a member of a social network and received from a provider of the social network. For example, FIG. 2 shows task of acquiring data request from member of social network receiving from social network provider module 218 receiving a request to carry out a task of acquiring data (e.g., “determine how much sunlight east-facing apartments on South Street get in the mornings”) requested by a member of a social network (e.g., a discrete interface device registered on MySpace, or a user that has an account with MySpace) and received from a provider of the social network (e.g., MySpace actually sends the request to carry out a task of acquiring data even though the task requestor is the discrete interface device on which the user sent the request to MySpace).

Referring again to FIG. 6B, operation 612 may include operation 620 depicting receiving a request to carry out a task of acquiring data from a provider of an internet search engine. For example, FIG. 2 shows task of acquiring data request from internet search engine provider receiving module 220 receiving a request to carry out a task of acquiring data (e.g., “determine whether it is currently raining in the Fremont neighborhood of metro Seattle”) from a provider of an internet search engine (e.g., Yahoo!).

Referring again to FIG. 6B, operation 612 may include operation 622 depicting receiving a request to carry out a task of acquiring data from a provider of an interface device operating system. For example, FIG. 2 shows task of acquiring data request from interface device operating system provider receiving module 222 receiving a request to carry out a task of acquiring data (e.g., “determine which tables at La Blanca have a window view of the Space Needle”) from a provider of an interface operating system (e.g., Apple (e.g., iOS), or Google (e.g., Android), or Microsoft (e.g., Windows XP/Vista/7).

Referring again to FIG. 6B, operation 612 may include operation 624 depicting receiving a request to carry out a task of acquiring data from a distributor of interface devices. For example, FIG. 2 shows task of acquiring data request from interface device distributor receiving module 224 receiving a request to carry out a task of acquiring data (e.g. “determine whether there is more traffic on the SR 520 bridge or the I-90 bridge at 8:25 am on weekdays”) from a distributor of interface devices (e.g., Sprint, Samsung, HTC, AT&T, RIM).

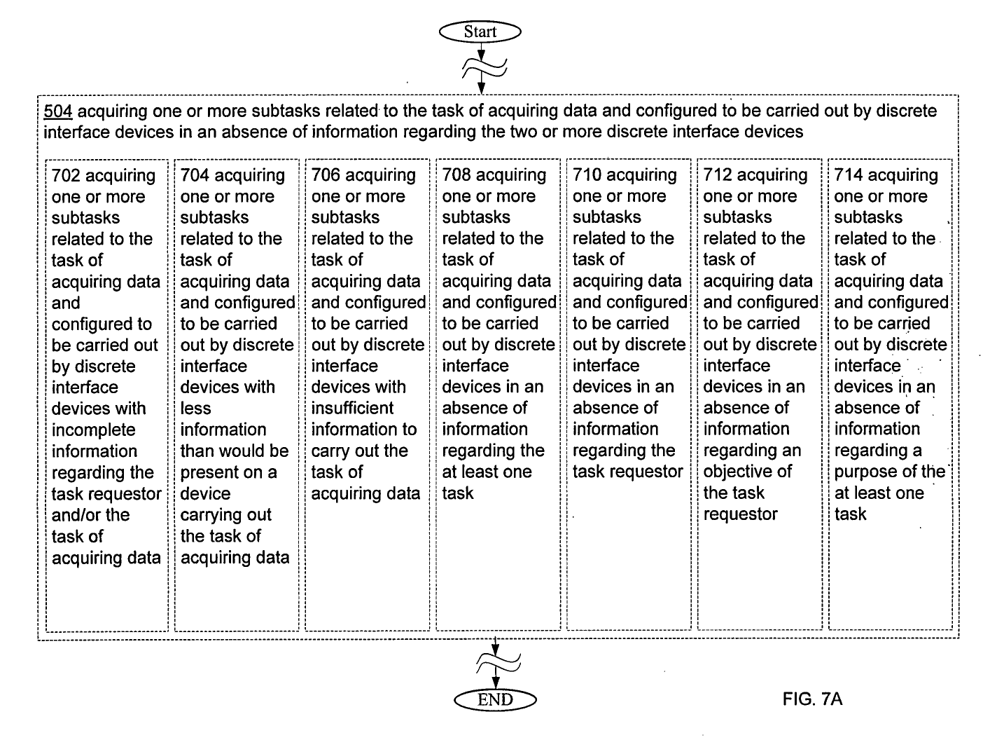

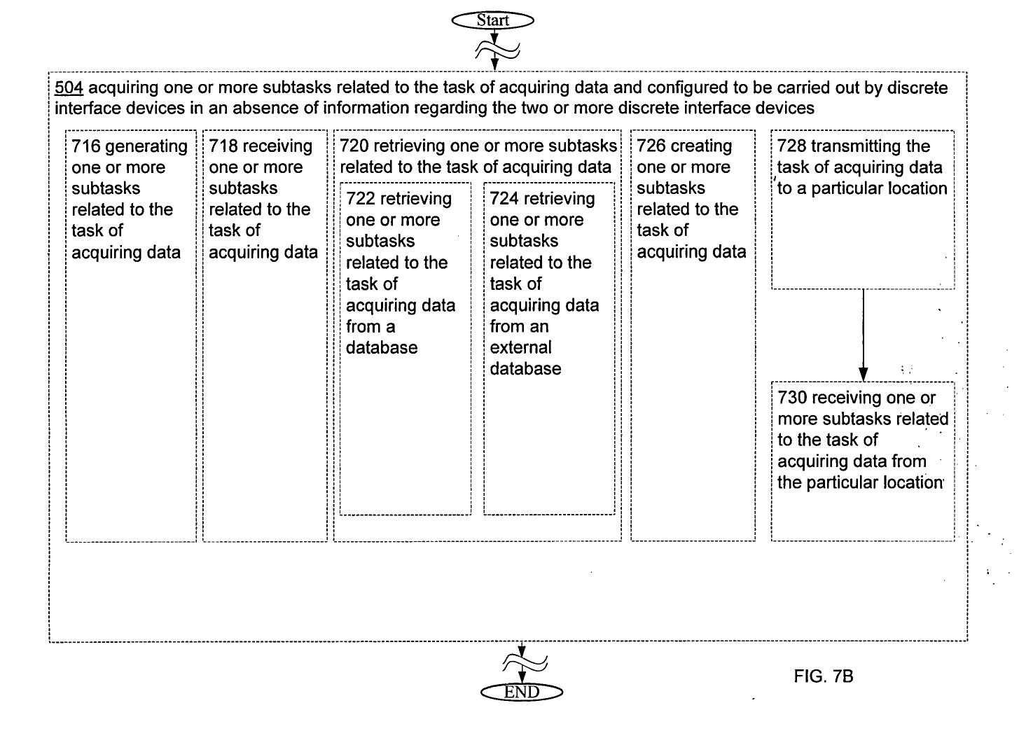

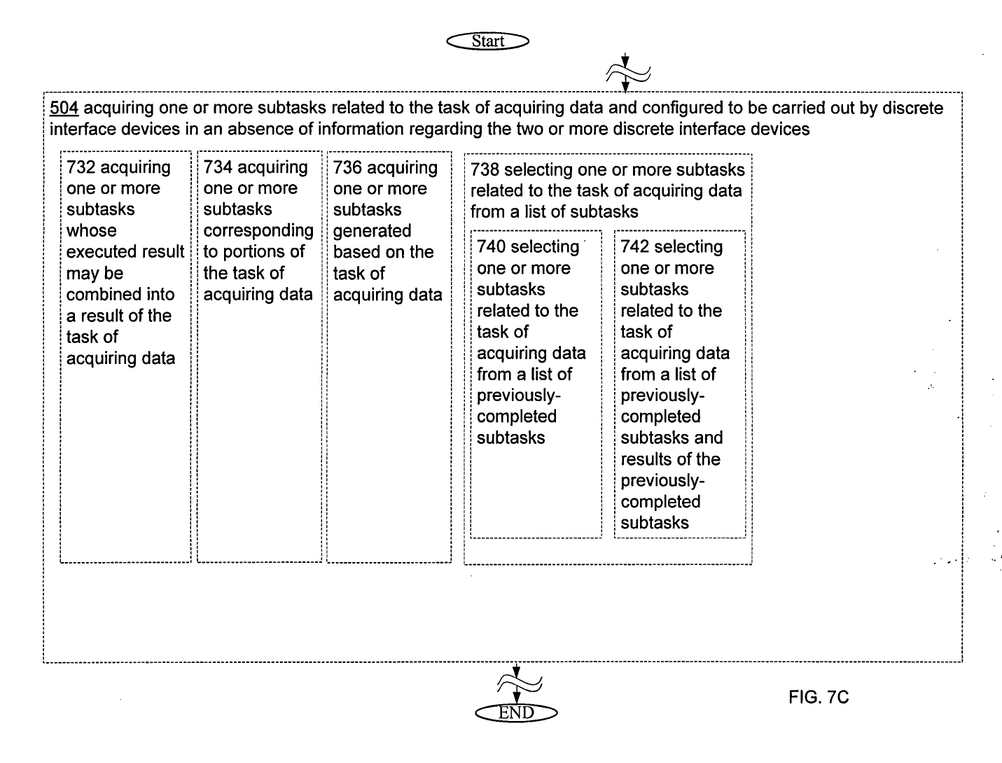

FIGS. 7A-7C depict various implementations of operation 504, according to embodiments. Referring now to FIG. 7A, operation 504 may include operation 702 depicting acquiring one or more subtasks related to the task of acquiring data and configured to be carried out by discrete interface devices with incomplete information regarding the task requestor and/or the task of acquiring data. For example, FIG. 3 shows two-or-more incomplete information configured subtask acquiring module 302 acquiring one or more subtasks (e.g., “determine how fast you are moving across the I-90 bridge at your location”) related to the task of acquiring data (e.g. “determine traffic levels for I-90 from Seattle to Bellevue right now”) and configured to be carried out by discrete interface devices (e.g., an iPhone in a glove box, and a Nokia E5 in a passenger's pocket), with incomplete information regarding the task requestor (e.g., the iPhone and Nokia E5 do not know the identity of the task requestor or the type of entity, e.g., personal, corporate, automated) and/or the task of acquiring data (e.g., the task of “determine the fastest way into Seattle at 4:25 PM from Bellevue, Wash.,” the iPhone and the Nokia E5 do not know the task, and whether it is “determine the fastest way,” or “monitor traffic conditions,” or any details about how the information the devices are gathering will be used, and to answer which queries).

Referring again to FIG. 7A, operation 504 may include operation 704 depicting acquiring one or more subtasks related to the task of acquiring data and configured to be carried out by discrete interface devices with less information than would be present on a device carrying out the task of acquiring data. For example, FIG. 3 shows two-or-more less information configured subtask acquiring module 304 acquiring one or more subtasks (e.g., “determine the view from your location at Safeco field”) related to the task of acquiring data (e.g. “determine how full the rows are in the upper deck at Safeco Field.”) and configured to be carried out by discrete interface devices (e.g., a Samsung Galaxy II and a Motorola Droid 3) with less information than would be present on a device carrying out the task of acquiring data (e.g., the Samsung Galaxy II and the Droid 3 only activate their image collecting component and collect data. The task is “determine how full the rows are in the upper deck at Safeco Field.” The devices have no idea whether they are capturing images of the fans in the stands, of the view, of the weather, of the sunlight, or of the best time to avoid shadows, or to determine whether the seats are covered. In contrast, a device carrying out the task by itself (which would have to go to each row of the park) would know to determine how full the rows are because of knowledge of the task).

Referring again to FIG. 7A, operation 504 may include operation 706 depicting acquiring one or more subtasks related to the task of acquiring data and configured to be carried out by discrete interface devices with insufficient information to carry out the task of acquiring data. For example, FIG. 3 shows two-or-more insufficient information configured subtask acquiring module 306 acquiring one or more subtasks (e.g., “determine the wireless network strength at McDonald's in Bellevue, Wash.) related to the task of acquiring data (e.g., “determine which McDonald's of the ones in Bellevue, Wash., have the fastest internet connection.”) and configured to be carried out by discrete interface devices (e.g., a Droid Revolution and a Nokia E650 smartphone) with insufficient information to carry out the task of acquiring data (e.g., the task of acquiring data is “determine which McDonald's of the ones in Bellevue, Wash., have the fastest internet connection.” The interface devices have insufficient information to complete this task because they are merely measuring wireless strength at McDonald's. They do not know whether to measure strength at various McDonald's, various types of signal strength at that McDonald's (e.g., cellular network strength), whether to measure the signal strength at a particular time, or over a particular period of time. The Droid Revolution and the Nokia E650 have insufficient information to carry out the entire task, but are capable of carrying out the subtask that was transmitted to them).

Referring again to FIG. 7A, operation 504 may include operation 708 depicting acquiring one or more subtasks related to the task of acquiring data and configured to be carried out by discrete interface devices in an absence of information regarding the at least one task. For example, FIG. 3 shows two-or-more discrete interface device absent task information configured discrete subtask acquiring module 308 acquiring one or more subtasks (e.g., “take a picture of Times Square”) related to the task of acquiring data (e.g. “take a 360-degree picture of Times Square when the new Reebok ad pops up at 8:01:32 a.m.,”) and configured to be carried out by discrete interface devices (e.g., Samsung Epic Touch smartphone, HTC Evo smartphone) in an absence of information regarding the at least one task (e.g., the task is “take a 360-degree picture of Times Square when the new Reebok ad pops up at 8:01:32 a.m.,” and the discrete interface devices do not have the information that this is the task).

Referring again to FIG. 7A, operation 504 may include operation 710 depicting acquiring one or more subtasks related to the task of acquiring data and configured to be carried out by discrete interface devices in an absence of information regarding the task requestor. For example, FIG. 3 shows two-or-more discrete interface device absent task requestor information configured discrete subtask acquiring module 310 acquiring one or more subtasks (e.g., “take a picture of Times Square”) related to the task of acquiring data (e.g. “take a 360-degree picture of Times Square when the new Reebok ad pops up at 8:01:32 a.m.,”) and configured to be carried out by discrete interface devices (e.g., Samsung Epic Touch smartphone, HTC Evo smartphone) in an absence of information regarding the at least one task requestor (e.g., the task is “take a 360-degree picture of Times Square when the new Reebok ad pops up at 8:01:32 a.m.,” and the task requestor is Reebok, and the discrete interface devices do not have the information regarding the task requestor, e.g., identity, or which type, e.g., corporate or personal, human or machine query).

Referring again to FIG. 7A, operation 504 may include operation 712 depicting acquiring one or more subtasks related to the task of acquiring data and configured to be carried out by discrete interface devices in an absence of information regarding an objective of the task requestor. For example, FIG. 3 shows two-or-more discrete interface device absent task requestor objective information configured discrete subtask acquiring module 312 acquiring one or more subtasks (e.g., “determine the loudness level at your seat during the Pearl Jam concert”) related to the task of acquiring data (e.g., “determine the loudness level for various acts at Key Arena”) and configured to be carried out by discrete interface devices (e.g., the iPhone 4 and the Samsung Focus S) in an absence of information regarding the at least one task (e.g. “determine how loud the crowd is for the Pearl Jam concert at Key Arena on September 19”) and/or without knowledge of an objective of the task requestor (e.g., the iPhone 4 and the Samsung Focus S do not know who made the request, the identity of the task requestor, or even whether the task requestor is a corporate entity interested in tracking Pearl Jam's popularity, an old lady trying to decide if the concert will be too loud for her, a young couple determining whether to bring their infant to the show, or a Pearl Jam fan site webmaster tracking information about Pearl Jam at shows that he cannot attend personally).

Referring again to FIG. 7A, operation 504 may include operation 714 depicting acquiring one or more subtasks related to the task of acquiring data and configured to be carried out by discrete interface devices in an absence of information regarding a purpose of the at least one task. For example, FIG. 3 shows two-or-more discrete interface device absent task purpose information configured discrete subtask acquiring module 314 acquiring one or more subtasks (e.g., “how much rain fell in your location in the last six hours”) related to the task of acquiring data (e.g., “track rainfall data in Seattle by neighborhood on January 21) and configured to be carried out by discrete interface devices (e.g., a smartphone with a precipitation detector, and a smartphone where the user is queried for an answer) in an absence of information regarding a purpose of the at least one task (e.g., the smartphones carrying out the task do not know if the purpose is to “track rainfall” or “determine where to visit in order to get sunshine,” or “predict the weather patterns moving east”).

Referring now to FIG. 7B, operation 504 may include operation 716 depicting generating one or more subtasks related to the task of acquiring data. For example, FIG. 3 shows related absent information configured subtask generating module 316 generating (e.g., using processors or human-assisted logic to create) one or more subtasks (e.g., “respond to a query regarding a length of the line in which you are currently standing”) related to the task of acquiring data (e.g., “determine which McDonald's drive thru that is a right turn off I-90 that has the shortest line”).

Referring again to FIG. 7B, operation 504 may include operation 718 depicting receiving one or more subtasks related to the task of acquiring data. For example, FIG. 3 shows related absent information configured subtask receiving module 318 receiving one or more subtasks (e.g., “respond to a query regarding how cloudy the sky is”) related to the task of acquiring data (e.g., “predict the weather over the next six hours in Belltown neighborhood”).

Referring again to FIG. 7B, operation 504 may include operation 720 depicting retrieving one or more subtasks related to the task of acquiring data. For example, FIG. 3 shows related absent information configured subtask retrieving module 320 retrieving (e.g., obtaining from a different location, e.g., in a local or remote memory) one or more subtasks (e.g., “activate the air quality sensor”) related to the task of acquiring data (“determine the exact pollen count right now at Arlington National Cemetery”).

Referring again to FIG. 7B, operation 720 may include operation 722 depicting retrieving one or more subtasks related to the task of acquiring data from a database. For example, FIG. 3 shows related absent information configured subtask database retrieving module 322 retrieving one or more subtasks (e.g., “determine the strongest unencrypted wireless network signal strength at your location) related to the task of acquiring data (e.g., “create a map of free wireless network coverage for Seattle, Wash.”) from a database (e.g., a database of subtasks that need to be completed that were previously requested by users for projects that may take some time to complete, and may remain ongoing for several days).

Referring again to FIG. 7B, operation 720 may include operation 724 depicting retrieving one or more subtasks related to the task of acquiring data from an external database. For example, FIG. 3 shows related absent information configured subtask external database retrieving module 324 retrieving one or more subtasks (e.g., “measure cellular network upload speed at your location”) related to the task of acquiring data (e.g. “determine thin spots in coverage for Verizon's 4G LTE network”) from an external database (e.g., a database maintained by Verizon of subtasks that they need to have completed).

Referring again to FIG. 7B, operation 504 may include operation 726 depicting creating one or more subtasks related to the task of acquiring data. For example, FIG. 3 shows related absent information configured subtask creating module 326 creating (e.g., applying logic rules and artificial or human intelligence to create without relying on retrieving old subtasks) one or more subtasks (e.g., “measure the wireless network signal strength at your location”) related to the task of acquiring data (e.g., “determine which Starbucks has the best wireless network connection today”).

Referring again to FIG. 7B, operation 504 may include operation 728 depicting transmitting the task of acquiring data to a particular location. For example, FIG. 3 shows particular location task transmitting module transmitting the task of acquiring data (e.g., “determine which seat at the Kennedy Center has the best view of the conductor for the London Philharmonic”) to a particular location (e.g., a location at which the task of acquiring data is broken down into subtasks). The particular location may be a server that handles the processing of tasks, or it may be a different computer on the network.

Referring again to FIG. 7B, operation 504 may also include operation 730 depicting receiving one or more subtasks related to the task of acquiring data from the particular location. For example, FIG. 3 shows particular location related absent information configured subtask receiving module 330 receiving one or more subtasks (e.g. “take a picture of the view you're your location at the Kennedy Center”) related to the task of acquiring data (e.g., “determine which seat at the Kennedy Center has the best view of the conductor for the London Philharmonic”) from the particular location (e.g., a location at which the task of acquiring data is broken down into subtasks). The particular location may be a server that handles the processing of tasks, or it may be a different computer on the network.

Referring now to FIG. 7C, operation 504 may include operation 732 depicting acquiring one or more subtasks whose executed result may be combined into a result of the task of acquiring data. For example, FIG. 3 shows related subtasks with results combined into task result acquiring module 332 acquiring one or more acquiring one or more subtasks (e.g., “for interface devices in proximity to Times Square, activate the image capturing sensor”) whose executed result (e.g., “pictures of Times Square”) may be combined into a result (e.g., a 360 degree near-real time picture) of the task of acquiring data (e.g., “acquire a 360 degree near-real time picture of Times Square”).

Referring again to FIG. 7C, operation 504 may include operation 734 depicting acquiring one or more subtasks corresponding to portions of the task of acquiring data. For example, FIG. 3 shows related subtasks corresponding to portions of task acquiring module 334 acquiring one or more subtasks (e.g., “determine the loudness level at your location on South Street”) corresponding to portions of the task of acquiring data (e.g., “determine which apartments on South Street have the lowest noise pollution level”). Here, the task of acquiring data, e.g., determine the apartments on South Street that have the lowest noise pollution level has subtasks including “determine the loudness level at your location on South Street,” which are portions of the overall task, e.g., when the subtasks are completed and combined, they may provide the result of the task of acquiring data.

Referring again to FIG. 7C, operation 504 may include operation 736 depicting acquiring one or more subtasks generated based on the task of acquiring data. For example, FIG. 3 shows related subtasks generated from task acquiring module 336 acquiring one or more subtasks (e.g. “determine the download speed for the fastest unencrypted wireless network at your location”) generated based on the task of acquiring data (e.g., “determine which coffee shops in Adams Morgan have the best free wireless signal”).

Referring again to FIG. 7C, operation 504 may include operation 738 depicting selecting one or more subtasks related to the task of acquiring data from a list of subtasks. For example, FIG. 3 shows related absent information configured subtask list selecting module 338 selecting one or more subtasks (e.g. “take a picture of the Washington Monument”) generated based on the task of acquiring data (e.g., “take a 360-degree picture of prominent Washington, D.C., icons”). The system may select one or more subtasks related to iconic Washington D.C. landmarks, e.g., subtasks that have been carried out before in other queries, or subtasks that are prepared by a Washington, D.C. tourist group for use by the subtask system.

Referring again to FIG. 7C, operation 738 may include operation 740 depicting selecting one or more subtasks related to the task of acquiring data from a list of previously-completed subtasks. For example, FIG. 3 shows previously completed subtask list subtask selecting module 340 selecting one or more subtasks (e.g., “take a picture of the Lincoln Memorial”) related to the task of acquiring data (e.g., “take a 360-degree near-real-time picture of the Lincoln Memorial”) from a list of previously-completed subtasks (e.g., with a common task of acquiring data, the subtask of “take a picture of the Lincoln Memorial” may have been previously carried out, and stored in a database or other format for retrieval as needed.

Referring again to FIG. 7C, operation 738 may include operation 742 depicting selecting one or more subtasks related to the task of acquiring data from a list of previously-completed subtasks and results of the previously-completed subtasks. For example, FIG. 3 shows previously completed subtask and result list subtask selecting module 342 selecting one or more subtasks (e.g., “take a picture of the White House lawn”) related to the task of acquiring data (e.g., “take a 360-degree picture of prominent Washington, D.C., icons”) from a list of previously-completed subtasks and results of the previously-completed subtasks (e.g., in this case, the task is not time-dependent, and pictures have previously been taken of the White House lawn, and these subtask results are retrieved along with the subtasks, after the task is broken down into subtasks.

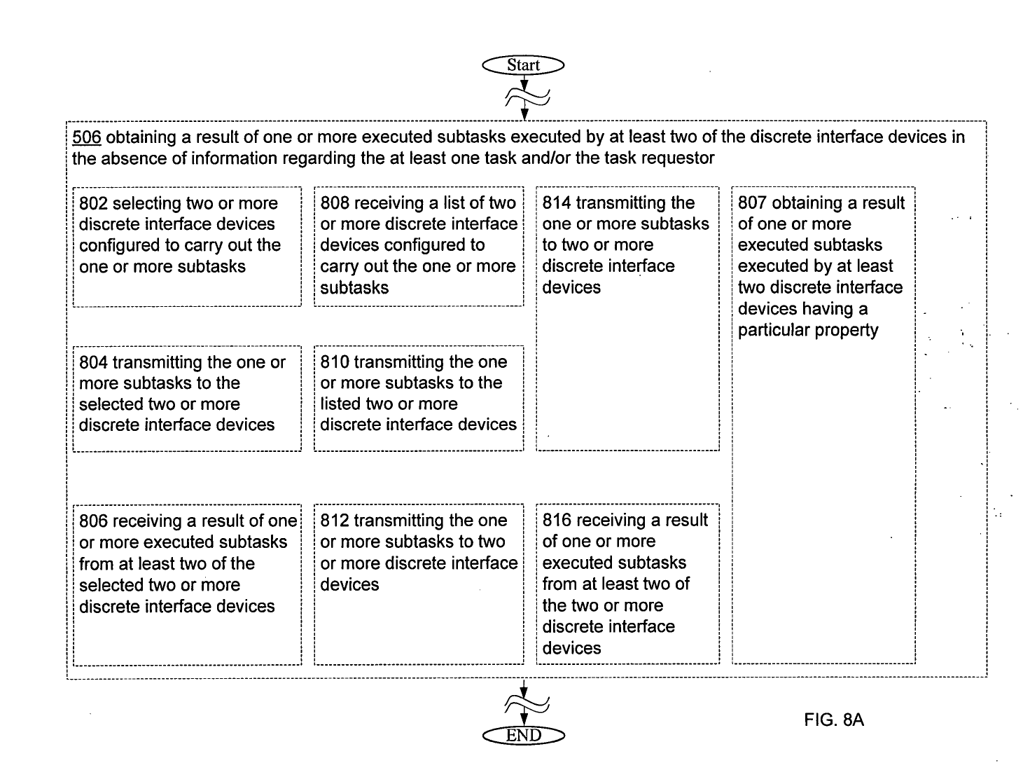

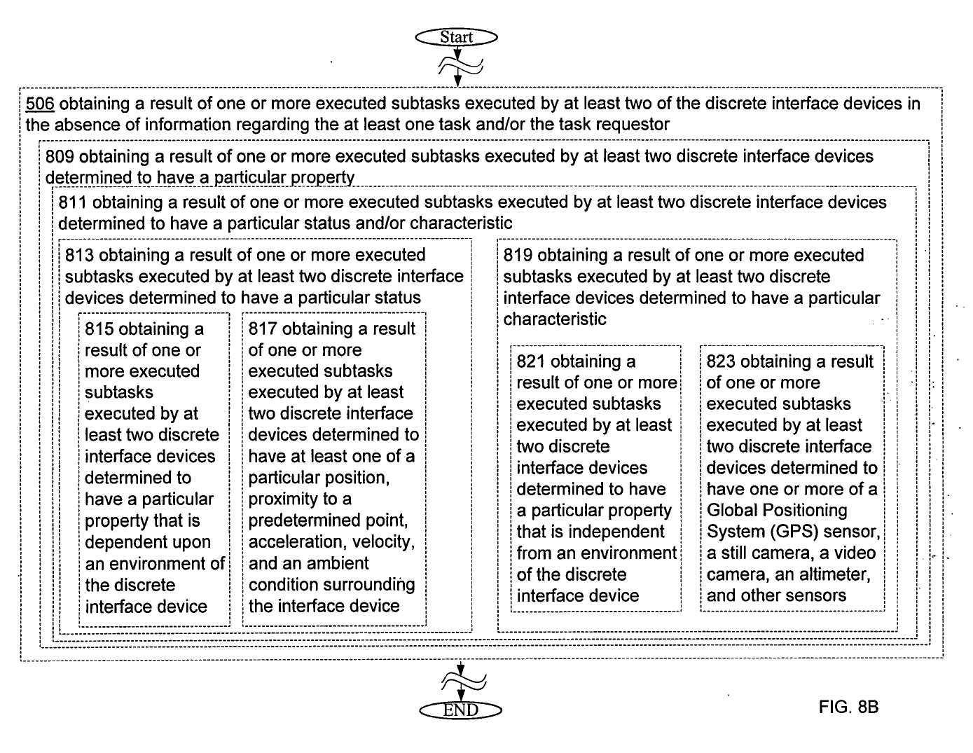

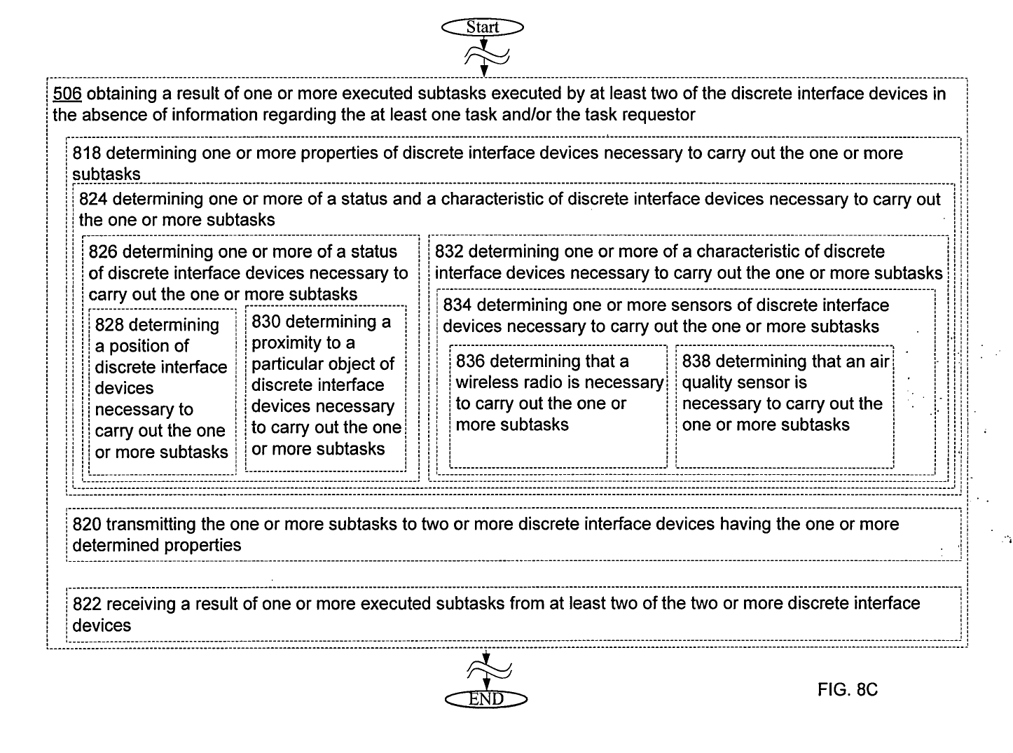

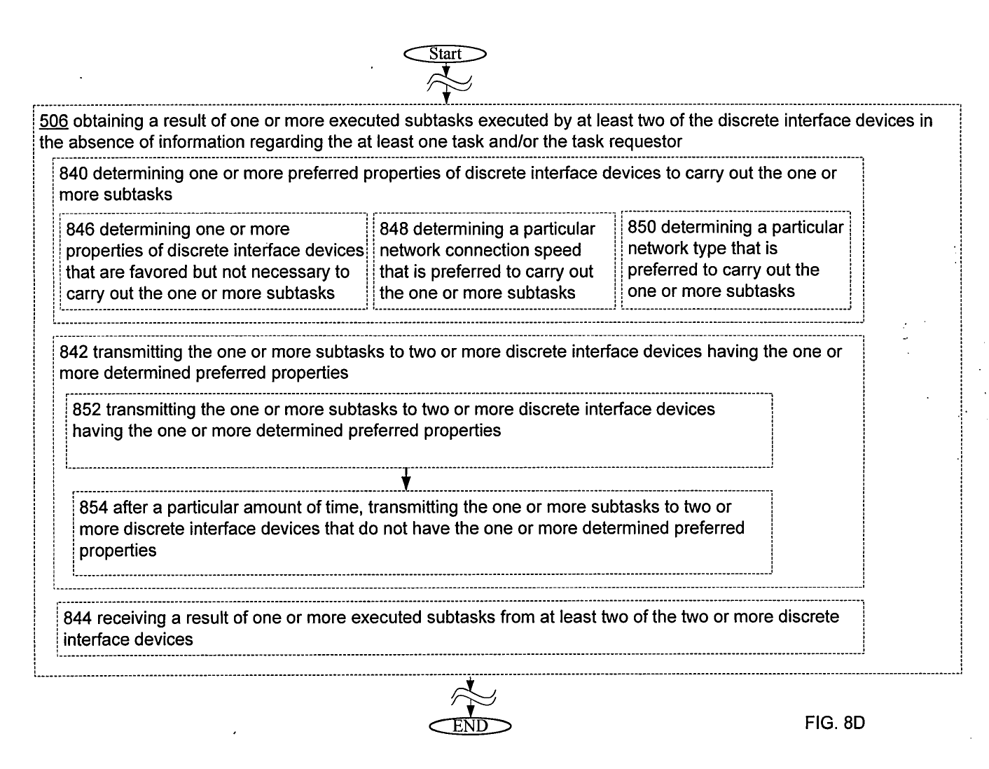

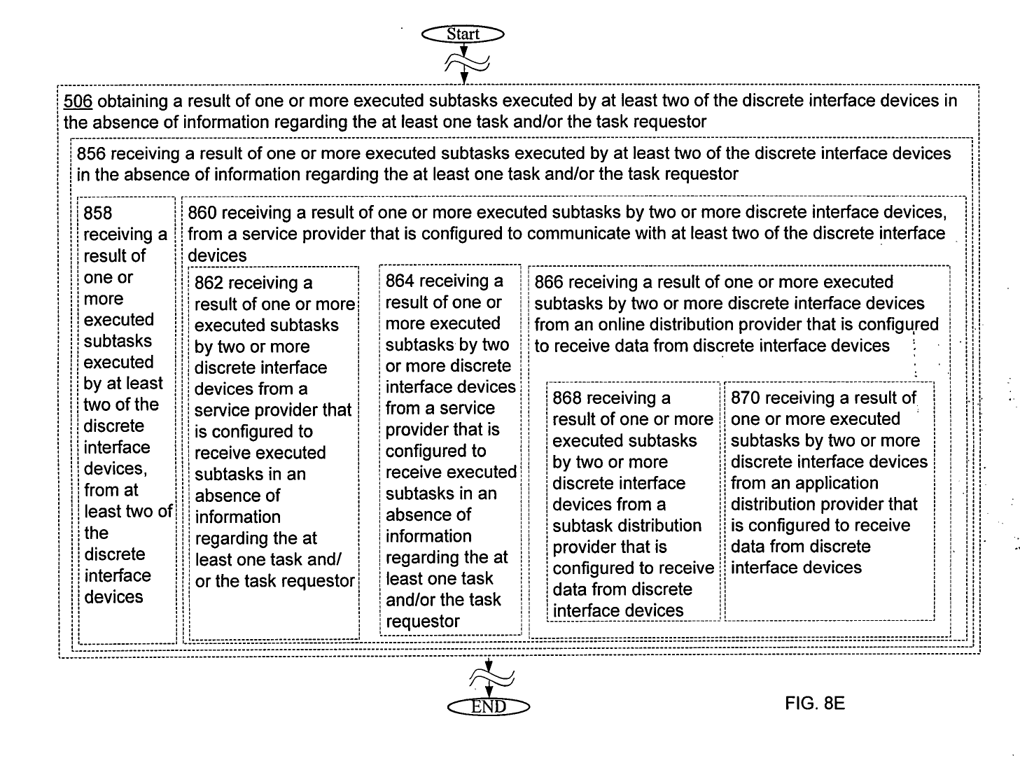

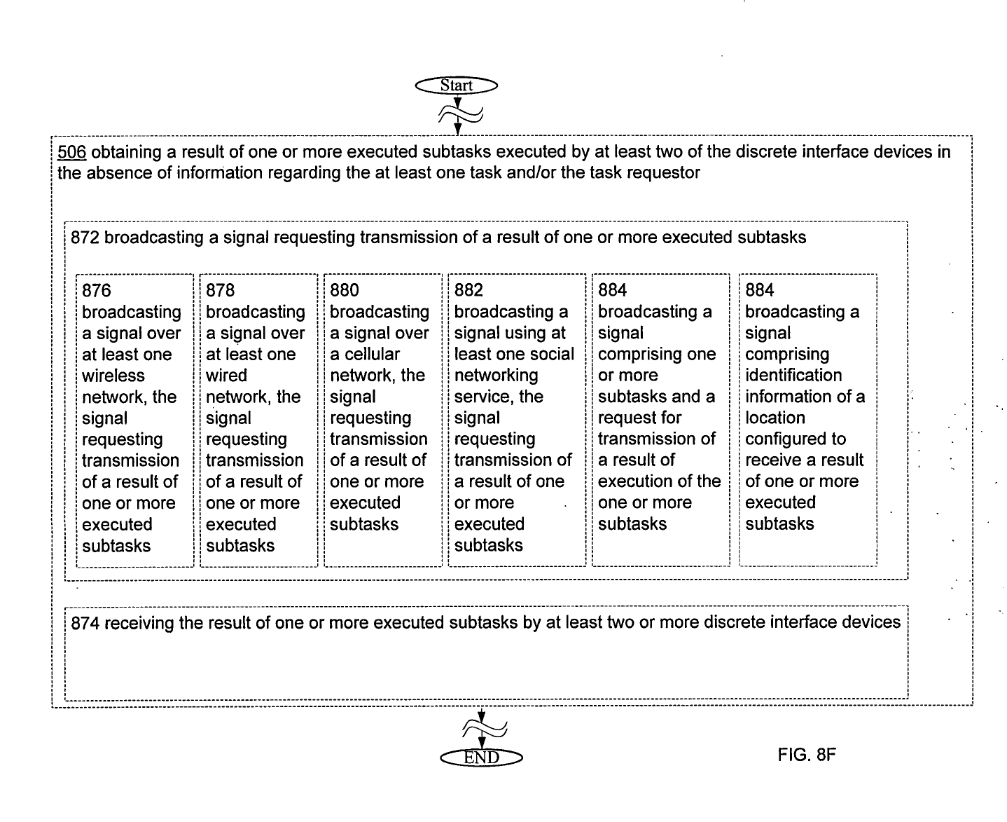

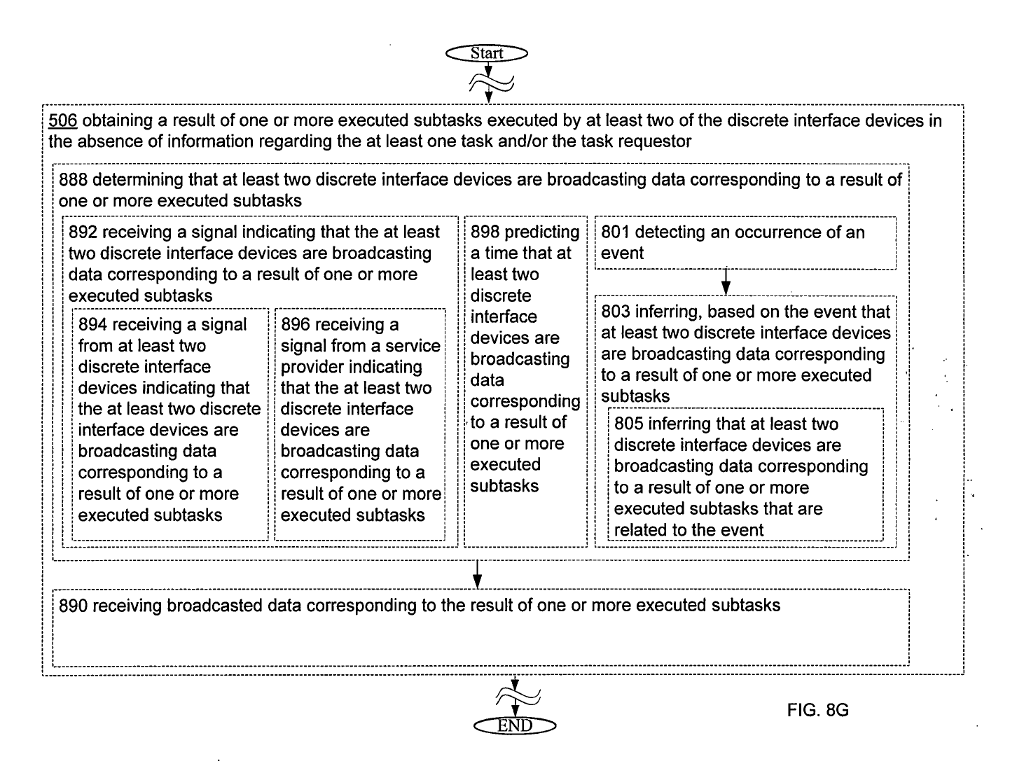

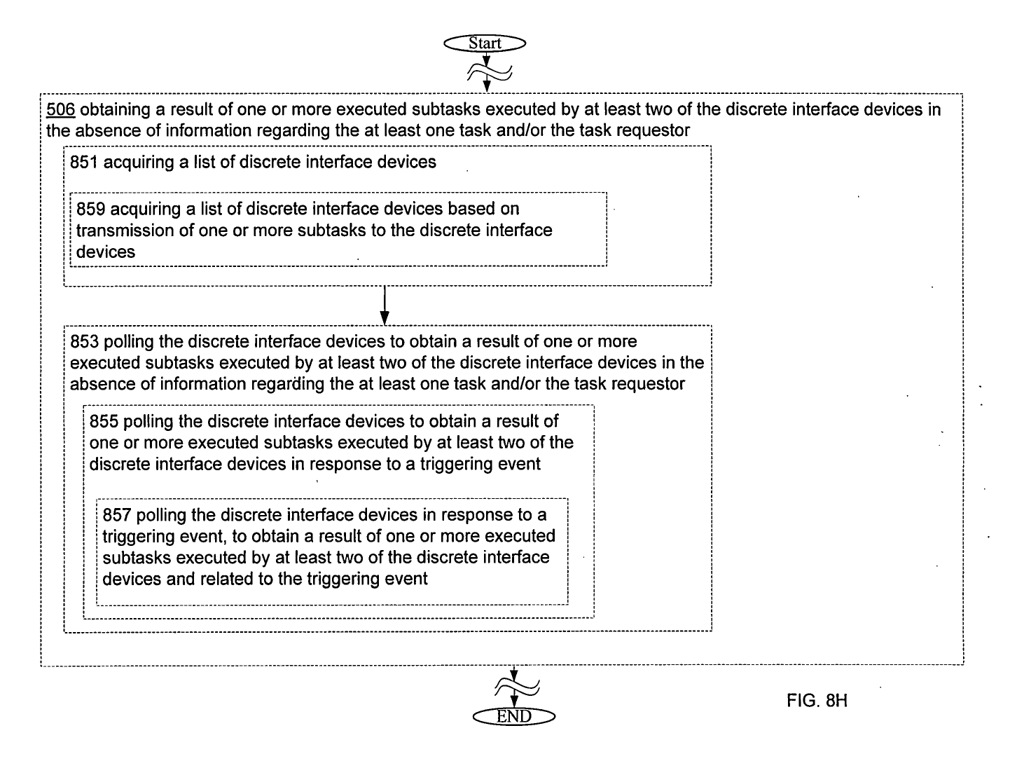

FIGS. 8A-8G depict various implementations of operation 506, according to embodiments. Referring now to FIG. 8A, operation 506 may include operation 802 depicting selecting two or more discrete interface devices configured to carry out the one or more subtasks. For example, FIG. 4 shows subtask-configured discrete interface device selecting module 402 selecting two or more discrete interface devices (e.g., the Apple iPhone 4, the Apple iPad 2, the Kodak Powershot 1100, and the Samsung Galaxy S II) configured to carry out the one or more subtasks (e.g., “take a picture of Mt. Rushmore,” and both the iPhone 4 and the Samsung Galaxy S II are configured to carry out the one or more subtasks because they have image capturing sensors).

Referring again to FIG. 8A, operation 506 may further include operation 804 depicting transmitting the one or more subtasks to the selected two or more discrete interface devices. For example, FIG. 4 shows subtask to discrete interface device transmitting module 404 transmitting the one or more subtasks (e.g., “Take a picture of Mt. Rushmore”) to the selected two or more discrete interface devices (e.g., the Apple iPhone 4, the Apple iPad 2, the Kodak Powershot 1100, and the Samsung Galaxy S II).

Referring again to FIG. 8A, operation 506 may further include operation 806 depicting receiving a result of one or more executed subtasks from at least two of the selected two or more discrete interface devices. For example, FIG. 4 shows two-or-more absent information discrete interface device executed subtask receiving module 406 receiving a result of one or more executed subtasks (e.g., the image data of the subtask “take a picture of Mt. Rushmore”) from at least two of the selected two or more discrete interface devices (e.g., the iPhone 4 and the Samsung Galaxy S II).

Referring again to FIG. 8A, operation 506 may include operation 808 depicting receiving a list of two or more discrete interface devices configured to carry out the one or more subtasks. For example, FIG. 4 shows two-or-more discrete interface device list receiving module 408 receiving a list of two or more discrete interface devices (e.g., a list of devices, either subscribers to a service, or visible devices on a network, or any list, either partially retrieved, fully retrieved, or retrieved as needed, or created or generated, from any location) configured to carry out the one or more subtasks (e.g., “measure the 4G LTE signal strength at your location” is the subtask, and any device with a 4G LTE antenna is configured to carry out the one or more subtasks).

Referring again to FIG. 8A, operation 506 may include operation 810 depicting transmitting the one or more subtasks to the listed two or more discrete interface devices. For example, FIG. 4 shows listed discrete interface device subtask transmitting module 410 transmitting the one or more subtasks (e.g., “measure the 4G LTE signal strength at your location”) to the listed two or more discrete interface devices (e.g., a Motorola Droid 4G, Samsung Epic Touch 4G, and a Pantech Breakout 4G).

Referring again to FIG. 8A, operation 506 may include operation 812 depicting receiving a result of one or more executed subtasks from at least two of the selected two or more discrete interface devices. For example, FIG. 4 shows two-or-more absent information listed discrete interface device executed subtask receiving module 412 receiving a result of one or more executed subtasks (e.g., “measure the 4G LTE signal strength at your location”) from at least two of the selected two or more discrete interface devices (e.g., a Samsung Epic Touch 4G, and a Pantech Breakout 4G).

Referring again to FIG. 8A, operation 506 may include operation 814 depicting transmitting the one or more subtasks to two or more discrete interface devices. For example, FIG. 4 shows subtask to two-or-more discrete interface device transmitting module 414 transmitting the one or more subtasks (e.g., “determine the temperature at your location”) to two or more discrete interface devices (e.g., an iPhone 4G, an OnStar-equipped Chevy Tahoe, and a WeatherScan home weather station).

Referring again to FIG. 8A, operation 506 may further include operation 816 depicting receiving a result of one or more executed subtasks from at least two of the two or more discrete interface devices. For example, FIG. 4 shows two-or-more absent information transmitted discrete interface device executed subtask receiving module 416 receiving a result of one or more executed subtasks (e.g., the temperature as determined from a temperature sensor, in response to the subtask of “determine the temperature at your location”) from at least two of the two or more discrete interface devices (e.g., the iPhone 4G, and the OnStar equipped Chevy Tahoe).

Referring again to FIG. 8A, operation 506 may include operation 807 depicting obtaining a result of one or more executed subtasks executed by at least two discrete interface devices having a particular property. For example, FIG. 4 shows two-or-more absent information discrete interface device having particular property executed subtask receiving module 407 obtaining a result of one or more executed subtasks (e.g., a response to the query sent as a subtask, where the query is “on a scale of 1 to 10, how fresh are the pastries at the Top Pot Doughnuts at which the discrete interface device is positioned currently”) executed by at least two discrete interface devices having a particular property (e.g., positioned inside a Top Pot Doughnuts).

Referring now to FIG. 8B, operation 506 may include operation 809 depicting obtaining a result of one or more executed subtasks executed by at least two discrete interface devices determined to have a particular property. For example, FIG. 4 shows determined particular property discrete interface device executed subtask receiving module 409 obtaining a result of one or more executed subtasks (e.g., image data in response to “capture image data inside a Starbucks,” a subtask corresponding to a portion of a task designed to estimate how crowded various Starbucks stores are) executed by at least two discrete interface devices determined to have a particular property (e.g., have a camera, and are positioned inside a Starbucks, which is determined by the Starbucks servers based on the discrete interface devices that are logged on to Starbucks's wireless networks, and publicly available information about the device to determine whether the device has a camera).

Referring again to FIG. 8B, operation 809 may include operation 811 depicting obtaining a result of one or more executed subtasks executed by at least two discrete interface devices determined to have a particular status and/or characteristic. For example, FIG. 4 shows determined particular status and/or characteristic discrete interface device executed subtask receiving module 411 obtaining a result of one or more executed subtasks (e.g., speed information as a result in response to the subtask “how fast are you moving along I-90 at your current position”) executed by at least two discrete interface devices (e.g., an OnStar-equivalent equipped Ford Taurus and a TomTom GPS device) determined to have a particular status and/or characteristic (e.g., has a speedometer).

Referring again to FIG. 8B, operation 811 may include operation 813 depicting obtaining a result of one or more executed subtasks executed by at least two discrete interface devices determined to have a particular status. For example, FIG. 4 shows determined particular status discrete interface device executed subtask receiving module 413 obtaining a result of one or more executed subtasks (e.g., brightness data from an image capturing sensor or photovalic cell in response to the subtask “determine the brightness outside of the building at your location”) executed by at least two discrete interface devices (e.g., Apple iPhone 4 and Motorola Droid Razr) determined to have a particular status (e.g., are stationary and are inside a building).

Referring again to FIG. 8B, operation 813 may include operation 815 depicting obtaining a result of one or more executed subtasks executed by at least two discrete interface devices determined to have a particular property that is dependent upon an environment of the discrete interface device. For example, FIG. 4 shows determined particular environment dependent discrete interface device executed subtask receiving module 415 obtaining a result of one or more executed subtasks (e.g., image data in response to a subtask “determine the brightness of the CFL bulbs installed in your house”) executed by at least two discrete interface devices (e.g., Asus Transformer Prime and Dell Inspiron 15R laptop) determined to have a particular property that is dependent upon an environment of the discrete interface device (e.g., is detecting a brightness that falls within a lumen range indicating CFL lighting).

Referring again to FIG. 8B, operation 813 may include operation 817 depicting obtaining a result of one or more executed subtasks executed by at least two discrete interface devices determined to have at least one of a particular position, proximity to a predetermined point, acceleration, velocity, and an ambient condition surrounding the interface device. For example, FIG. 4 shows determined particular status list discrete interface device executed subtask receiving module 417 obtaining a result of one or more executed subtasks (e.g., loudness data in response to a subtask of “determine how loud the Pearl Jam concert is at your seats”) executed by at least two discrete interface devices (e.g., Sony PCM Portable Audio Recorder and a Samsung Galaxy Tab 10.1) determined to have at least one of a particular position, proximity to a predetermined point, acceleration, velocity, and an ambient condition surrounding the interface device (e.g., a detected loudness indicating a concert noise is detected).

Referring again to FIG. 8B, operation 811 may include operation 819 depicting obtaining a result of one or more executed subtasks executed by at least two discrete interface devices determined to have a particular characteristic. For example, FIG. 4 shows determined particular characteristic discrete interface device executed subtask receiving module 419 obtaining a result of one or more executed subtasks (e.g., loudness data in response to a subtask of “determine how loud the crowd gets when a goal is scored at the Washington Capitals ice hockey game”) executed by at least two discrete interface devices (e.g., an HTC Amaze and a Motorola Brute) determined to have a particular characteristic (e.g., a presence of a microphone).

Referring again to FIG. 8B, operation 819 may include operation 821 depicting obtaining a result of one or more executed subtasks executed by at least two discrete interface devices determined to have a particular property that is independent from an environment of the discrete interface device. For example, FIG. 4 shows determined particular environment independent discrete interface device executed subtask receiving module 421 obtaining a result of one or more executed subtasks (e.g., image data in response to a subtask of “capture the image data at Times Square at 8:05 am”) executed by at least two discrete interface devices (e.g., Samsung Focus S, Apple iPad 2) determined to have a particular property that is independent from an environment of the discrete interface device (e.g., has a camera).

Referring again to FIG. 8B, operation 819 may include operation 823 depicting obtaining a result of one or more executed subtasks executed by at least two discrete interface devices determined to have one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor. For example, FIG. 4 shows determined particular characteristic list discrete interface device executed subtask receiving module 423 obtaining a result of one or more executed subtasks (e.g., image data in response to a subtask of “take a picture of the Space Needle”) executed by at least two discrete interface devices (e.g., Canon PowerShot SD430 Digital Camera and Kodak Playsport) determined to have one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor.

Referring now to FIG. 8C, operation 506 may include operation 818 depicting determining one or more properties of discrete interface devices necessary to carry out the one or more subtasks. For example, FIG. 4 shows necessary property discrete interface device determining module 418 determining one or more properties (e.g., has an image capturing sensor) necessary to carry out the one or more subtasks (e.g., “take a picture of the Space Needle”).

Referring again to FIG. 8C, operation 506 may further include operation 820 depicting transmitting the one or more subtasks to two or more discrete interface devices having the one or more determined properties. For example, FIG. 4 shows determined discrete interface device having property subtask transmitting module 420 transmitting the one or more subtasks (e.g., “take a picture of the Space Needle”) to two or more discrete interface devices (e.g., Apple iPhone 4, Nokia E5) having the one or more determined properties (e.g., each of the Apple iPhone 4 and Nokia E5 has an image capturing sensor).

Referring again to FIG. 8C, operation 506 may further include operation 822 depicting receiving a result of one or more executed subtasks from at least two of the two or more discrete interface devices. For example, FIG. 4 shows two-or-more absent information discrete interface device executed determined subtask receiving module 422 receiving a result (e.g., image data of the Space Needle) of one or more executed subtasks (e.g., “take a picture of the Space Needle”) from at least two of the two or more discrete interface devices (e.g., the iPhone 4 and the Nokia E5).

Referring again to FIG. 8C, operation 818 may include operation 824 depicting determining one or more of a status and a characteristic of discrete interface devices necessary to carry out the one or more subtasks. For example, FIG. 4 shows necessary status and/or characteristic discrete interface device determining module 424 determining one or more of a status (e.g., an environment-dependent property) and a characteristic (e.g., an environment independent property) of discrete interface devices (e.g., the HTC Evo and the BlackBerry Bold) necessary to carry out the one or more subtasks (e.g., “determine barometric pressure at your location,” as a subtask, and a necessary characteristic would be “has a barometer”).

Referring again to FIG. 8C, operation 824 may include operation 826 depicting determining one or more of a status of discrete interface devices necessary to carry out the one or more subtasks. For example, FIG. 4 shows necessary status discrete interface device determining module 426 determining one or more of a status (e.g., an environment-dependent property) of discrete interface devices (e.g., the Motorola Droid Razr and the HP Touchpad) necessary to carry out the one or more subtasks (e.g., a subtask of “determine how many people are sitting in your row at Safeco Field” has a necessary status of “be positioned in a seat at Safeco Field”).

Referring again to FIG. 8C, operation 826 may include operation 828 depicting determining a position of discrete interface devices necessary to carry out the one or more subtasks. For example, FIG. 4 shows proximity-based discrete interface device determining module 428 determining a position (e.g., “in Seattle”) of discrete interface devices (e.g., an OnStar equipped Chevy Volt, and a Garmin Nuvi GPS system) necessary to carry out the one or more subtasks (e.g., “determine the traffic through Mercer St. in Seattle at the current time”).

Referring again to FIG. 8C, operation 826 may include operation 830 depicting determining a proximity to a particular object of discrete interface devices necessary to carry out the one or more subtasks. For example, FIG. 4 shows proximity-based discrete interface device determining module 430 determining a proximity to a particular object (e.g., how close is the discrete interface device to the Space Needle) of discrete interface devices (e.g., the Motorola Xoom and the Acer Iconia) necessary to carry out the one or more subtasks (e.g., “take a picture of the Space Needle”).

Referring again to FIG. 8C, operation 824 may include operation 832 depicting determining one or more of a characteristic of discrete interface devices necessary to carry out the one or more subtasks. For example, FIG. 4 shows necessary characteristic discrete interface device determining module 432 determining one or more of a characteristic (e.g., an environment-independent property, e.g., a presence of a seismometer) of discrete interface devices (e.g., a Guralp CMG-6T portable broadband seismometer) necessary to carry out the one or more subtasks (e.g., track seismic activity across the west coast on Saturday, July 21).

Referring again to FIG. 8C, operation 832 may include operation 834 depicting determining one or more sensors of discrete interface devices necessary to carry out the one or more subtasks. For example, FIG. 4 shows sensor-based discrete interface device determining module 434 determining one or more sensors (e.g., a temperature sensor) of discrete interface devices (e.g., a wireless home weather station, a thermometer-equipped laptop computer) necessary to carry out the one or more subtasks (e.g., “determine the hottest part of Alki Beach”).

Referring again to FIG. 8C, operation 834 may include operation 836 depicting determining that a wireless radio is necessary to carry out the one or more subtasks. For example, FIG. 4 shows wireless radio-based discrete interface device determining module 436 determining that a wireless radio is necessary to carry out the one or more subtasks (e.g., “determine how many unencrypted wireless networks are visible at your location”).

Referring again to FIG. 8C, operation 834 may include operation 838 depicting determining that an air quality sensor is necessary to carry out the one or more subtasks. For example, FIG. 4 shows air quality sensor-based discrete interface device determining module 438 determining that an air quality sensor is necessary to carry out the one or more subtasks (e.g., “determine the pollen count in Cleveland Park today”).

Referring now to FIG. 8D, operation 506 may include operation 840 depicting determining one or more preferred properties of discrete interface devices to carry out the one or more subtasks. For example. FIG. 4 shows discrete interface device preferred property determining module 440 determining one or more preferred (e.g., not strictly necessary, but useful in facilitating the carrying out of subtasks) properties of discrete interface devices (e.g., higher megapixel camera, more powerful transmitting radio, more accurate microphone) to carry out the one or more subtasks (e.g., “take a picture of the Space Needle”).

Referring again to FIG. 8D, operation 506 may include operation 842 depicting transmitting the one or more subtasks to two or more discrete interface devices having the one or more determined preferred properties. For example, FIG. 4 shows preferred property discrete interface device subtask transmitting module 442 transmitting the one or more subtasks (e.g., “transmit video data of Times Square from your location”) to two or more discrete interface devices (e.g., the iPad 2 and the Samsung Galaxy Tab) having the one or more determined preferred properties (e.g., because video is being transmitted, a preferred property is “connect to the network with an upload speed of greater than 3 MB/s”).

Referring again to FIG. 8D, operation 506 may include operation 844 depicting receiving a result of one or more executed subtasks from at least two of the two or more discrete interface devices. For example, FIG. 4 shows executed subtask from preferred property discrete interface device receiving module 444 receiving a result of one or more executed subtasks (e.g., receiving video data as a result of the subtask “transmit video data of Times Square from your location”)

Referring again to FIG. 8D, operation 840 may include operation 846 depicting determining one or more properties of discrete interface devices that are favored but not necessary to carry out the one or more subtasks. For example, FIG. 4 shows favored but not necessary property determining module 446 determining one or more properties (e.g., sensitivity of microphone on the interface device) of discrete interface devices (e.g., Sony Personal Digital Recorder and Samsung Galaxy SII) that are favored but not necessary (e.g., more sensitive microphone will detect loudness more accurately) to carry out the one or more subtasks (e.g., “transmit loudness data from your location at the Stone Temple Pilots concert”).

Referring again to FIG. 8D, operation 840 may include operation 848 depicting determining a particular network connection speed for discrete interface devices that is preferred to carry out the one or more subtasks. For example, FIG. 4 shows preferred particular network connection speed discrete interface device determining module 448 determining a particular network connection speed e.g., connected to a network providing upload speed of greater than 3 MB/s) of discrete interface devices (e.g., Motorola Xoom, HP Touchpad) that is preferred to carry out the one or more subtasks (e.g., “capture image data inside the Peet's Coffee,” because greater upload speed will allow data from this subtask to be transmitted more smoothly).

Referring again to FIG. 8D, operation 840 may include operation 850 depicting determining a particular network type that is preferred to carry out the one or more subtasks. For example, FIG. 4 shows preferred particular network type discrete interface device determining module 450 determining a particular network type (e.g., Verizon 4G LTE network) that is preferred (e.g., Verizon may be a task requestor and may want to use its network to collect data, or use its subscribers to carry out subtasks because it can retrieve more information regarding these discrete interface devices) to carry out the one or more subtasks (e.g., “query regarding the freshness of the coffee at Tully's Coffee in Seattle”)

Referring again to FIG. 8D, operation 842 may include operation 852 depicting transmitting the one or more subtasks to two or more discrete interface devices having the one or more determined preferred properties. For example, FIG. 4 shows determined preferred property discrete interface device subtask transmitting module 452 transmitting the one or more subtasks (e.g., “take a picture of the U.S. Constitution at the National Archives”) to two or more discrete interface devices (e.g., a Samsung Epic 4G and an Apple iPhone 4S) having the one or more determined preferred properties (e.g., a camera having greater than six megapixel resolution).

Referring again to FIG. 8D, operation 842 may include operation 854 depicting after a particular amount of time, transmitting the one or more subtasks to two or more discrete interface devices that do not have the one or more determined preferred properties. For example, FIG. 4 shows delayed determined nonpreferred property discrete interface device subtask transmitting module 454 after a particular amount of time (e.g., after one hour, e.g., if no one is available to carry out the subtasks or cannot carry out the subtasks), transmitting the one or more subtasks (e.g., “take a picture of the U.S. Constitution at the National Archives”) to two or more discrete interface devices (e.g., the BlackBerry 8800 and the Nokia E5) that do not have the one or more determined preferred properties (e.g., each of the BlackBerry 8800 and the Nokia E5 have cameras, but the resolution for the cameras is below six megapixels.

Referring now to FIG. 8E, operation 506 may include operation 856 depicting receiving a result of one or more executed subtasks executed by at least two of the discrete interface devices in the absence of information regarding the at least one task and/or the task requestor. For example, FIG. 4 shows two-or-more absent information discrete interface device-executed subtask receiving module 456 receiving a result of one or more executed subtasks (e.g., mold spore counts as a result of the subtask of “determine which neighborhoods in Washington D.C. have the lowest mold spore count in the summer months”) executed by at least two of the discrete interface devices in the absence of information regarding the at least one task and/or the task requestor.

Referring again to FIG. 8E, operation 506 may include operation 858 depicting receiving a result of one or more executed subtasks executed by at least two of the discrete interface devices, from at least two of the discrete interface devices. For example, FIG. 4 shows two-or-more absent information discrete interface device-executed subtask receiving from discrete interface devices module 458 receiving a result of one or more executed subtasks (e.g., image data as a result of the subtask of “take a picture of the sun setting over Puget Sound in the evening”) executed by at least two of the discrete interface devices (e.g., the BlackBerry Torch and the HTC Rezound), from at least two of the discrete interface devices (e.g., the BlackBerry Torch and the HTC Rezound each transmit the result of the executed subtasks, e.g., they are not filtered through an intermediary).

Referring again to FIG. 8E, operation 856 may include operation 860 depicting receiving a result of one or more executed subtasks by two or more discrete interface devices, from a service provider that is configured to communicate with at least two of the discrete interface devices. For example, FIG. 4 shows two-or-more absent information discrete interface device-executed subtask receiving from service provider module 460 receiving a result of one or more executed subtasks (e.g., image data as a result of the subtask of “take a picture of the interior of Club Fever between 11 pm and 12 midnight”) by two or more discrete interface devices (e.g., Apple iPhone 4 and HTC Amaze 4G), from a service provider that is configured to communicate with at least two of the discrete interface devices (e.g., MySpace, which may receive the image data uploaded from the iPhone 4 and the Amaze 4G).

Referring again to FIG. 8E, operation 860 may include operation 862 depicting receiving a result of one or more executed subtasks by two or more discrete interface devices from a service provider that is configured to receive executed subtasks in an absence of information regarding the at least one task and/or the task requestor. For example, FIG. 4 shows two-or-more absent information discrete interface device-executed subtask receiving from absent information service provider module 462 receiving a result of one or more executed subtasks (e.g., image data in response to the subtask “take a picture of the Eiffel Tower”) by two or more discrete interface devices (e.g., a BlackBerry Bold and an HTC Sensation) from a service provider (e.g., Google Picasa) that is configured to receive executed subtasks (e.g., image data, e.g., how Google Picasa allows uploading and sharing of pictures) in an absence of information regarding the at least one task and/or the task requestor (e.g., the pictures are uploaded to Google Picasa, but Google Picasa does not know anything about the at least one task or the task requestor.

Referring again to FIG. 8E, operation 860 may include operation 864 depicting receiving a result of one or more executed subtasks by two or more discrete interface devices from a provider of a communication network that is configured to communicate with at least two of the discrete interface devices. For example, FIG. 4 shows two-or-more absent information discrete interface device-executed subtask receiving from communication network provider module 464 receiving a result of one or more executed subtasks (e.g., image data from a “take a picture of the Mona Lisa” subtask) by two or more discrete interface devices (e.g., Samsung Galaxy Nexus, Sony Ericcson Xperia) from a provider of a communication network (e.g., AT&T) that is configured to communicate with at least two of the discrete interface devices (e.g., the AT&T 3G network is configured to communicate with the Nexus and the Xperia).

Referring again to FIG. 8E, operation 860 may include operation 866 depicting receiving a result of one or more executed subtasks by two or more discrete interface devices from an online distribution provider that is configured to receive data from discrete interface devices. For example, FIG. 4 shows two-or-more absent information discrete interface device-executed subtask receiving from online distribution provider module 466 receiving a result of one or more executed subtasks (e.g., image data from a subtask of “take a picture of home plate from your seat at Safeco Field”) by two or more discrete interface devices (e.g., the Apple iPhone 4 and the Apple iPad) from an online distribution provider (e.g., Apple, e.g., the Apple Application Store) that is configured to receive data from discrete interface devices.

Referring again to FIG. 8E, operation 866 may include operation 868 depicting receiving a result of one or more executed subtasks by two or more discrete interface devices from a subtask distribution provider that is configured to receive data from discrete interface devices. For example, FIG. 4 shows two-or-more absent information discrete interface device-executed subtask receiving from online distribution provider interface device data receiving module 468 receiving a result of one or more executed subtasks (e.g., wireless network strength data from a “determine a strength of the wireless network at your location” subtask) by two or more discrete interface devices (e.g., a BlackBerry Bold and a BlackBerry Torch) from a subtask distribution provider (e.g., a server that distributes subtasks) that is configured to receive data from discrete interface devices.

Referring again to FIG. 8E, operation 866 may include operation 870 depicting receiving a result of one or more executed subtasks by two or more discrete interface devices from an application distribution provider that is configured to receive data from discrete interface devices. For example, FIG. 4 shows two-or-more absent information discrete interface device-executed subtask receiving from application distribution provider interface device data receiving module 468 receiving a result of one or more executed subtasks (e.g., mold spore counts from a subtask of “determine which neighborhoods in Washington D.C. have the lowest mold spore count in the summer months”) by two or more discrete interface devices (e.g., a BlackBerry Bold and a BlackBerry Playbook) from an application distribution provider (e.g., BlackBerry App World) that is configured to receive data from discrete interface devices).

Referring now to FIG. 8F, operation 506 may include operation 872 depicting broadcasting a signal requesting transmission of a result of one or more executed subtasks. For example, FIG. 4 shows transmission request for result of executed subtask broadcasting module 472 broadcasting a signal requesting transmission of a result (e.g., image data) of one or more executed subtasks (e.g., take a picture of Times Square from your location while facing east).

Referring again to FIG. 8F, operation 506 may include operation 874 depicting receiving the result of one or more executed subtasks by at least two or more discrete interface devices. For example, FIG. 4 shows transmission of result of executed subtask receiving module 474 receiving the result (e.g., image data) of one or more executed subtasks (e.g., take a picture of Times Square from your location while facing east) by at least two or more discrete interface devices (e.g., a Pantech Breakout and a Pantech Pocket).

Referring again to FIG. 8F, operation 872 may include operation 876 depicting broadcasting a signal over at least one wireless network, the signal requesting transmission of a result of one or more executed subtasks. For example, FIG. 4 shows transmission request for result of executed subtask wireless network signal broadcasting module 476 broadcasting a signal over at least one wireless network (e.g., a wireless home network), the signal requesting transmission of a result (e.g., barometer data) of one or more executed subtasks (e.g., “determine the change in barometric pressure between 5 pm and 6 pm”).

Referring again to FIG. 8F, operation 872 may include operation 878 depicting broadcasting a signal over at least one wired network, the signal requesting transmission of a result of one or more executed subtasks. For example, FIG. 4 shows transmission request for result of executed subtask wired network signal broadcasting module 478 broadcasting a signal over at least one wired network (e.g., an internal company network) requesting transmission of a result (e.g., temperature data) of one or more executed subtasks (e.g., “determine the temperature at 5:02 pm”).

Referring again to FIG. 8F, operation 872 may include operation 880 depicting broadcasting a signal over a cellular network, the signal requesting transmission of a result of one or more executed subtasks. For example, FIG. 4 shows transmission request for result of executed subtask cellular network signal broadcasting module 480 broadcasting a signal over a cellular network (e.g., AT&T's EDGE network), the signal requesting transmission of a result (e.g., loudness data) of one or more executed subtasks (e.g., “determine the loudness at the Matt & Kim concert at your location”).

Referring again to FIG. 8F, operation 872 may include operation 882 depicting broadcasting a signal using at least one social networking service, the signal requesting transmission of a result of one or more executed subtasks. For example, FIG. 4 shows transmission request for result of executed subtask broadcasting using social network service module 482 broadcasting a signal using at least one social networking service (e.g., sending a request using Facebook channels, e.g., posting a message, or internally signaling registered devices), the signal requesting transmission of a result of one or more executed subtasks (e.g., loudness data of one or more executed subtasks (e.g., “determine the loudness at Verizon Center when Alex Ovechkin scores a goal”).

Referring again to FIG. 8F, operation 872 may include operation 884 depicting broadcasting a signal comprising one or more subtasks and a request for transmission of a result of execution of the one or more subtasks. For example, FIG. 4 shows subtask and request for transmitting result of executed subtask broadcasting module 484 broadcasting a signal comprising one or more subtasks (e.g., “take a picture of Mt. Rainier from the Space Needle”) and a request for transmission of a result of execution (e.g., image data) of the one or more subtasks (e.g., “take a picture of Mt. Rainier from the Space Needle”).

Referring again to FIG. 8F, operation 872 may include operation 886 depicting broadcasting a signal comprising identification information of a location configured to receive a result of one or more executed subtasks. For example, FIG. 4 shows subtask and request for transmitting result of executed subtask to identified location broadcasting module 486 broadcasting a signal comprising identification information of a location (e.g., a server set up to receive subtask data, which may be under the control of a separate entity, e.g., Google or Facebook) configured to receive a result of one or more executed subtasks (e.g., image data from a subtask of “take a picture of the pastries at Mom's Country Kitchen restaurant in Falls Church, Va.).

Referring now to FIG. 8G, operation 506 may include operation 888 depicting determining that at least two discrete interface devices are broadcasting data corresponding to a result of one or more executed subtasks. For example, FIG. 4 shows discrete interface device broadcast determining module 488 determining (e.g., operating hardware, software, or both, that determines that broadcasting is occurring) that at least two discrete interface devices (e.g., a Motorola Droid Razr and a Motorola Droid 3) are broadcasting data corresponding to a result of one or more executed subtasks (e.g., image data from a subtask of “take a picture of Times Square at midnight on New Years' Eve”).

Referring again to FIG. 8G, operation 506 may include operation 890 depicting receiving broadcasted data corresponding to the result of one or more executed subtasks. For example, FIG. 4 shows broadcasted subtask result data discrete interface device receiving module receiving broadcasted data (e.g., image data) corresponding to the result of one or more executed subtasks (e.g., “take a picture of Times Square at midnight on New Years' Eve”).

Referring again to FIG. 8G, operation 888 may include operation 892 depicting receiving a signal indicating that the at least two discrete interface devices are broadcasting data corresponding to a result of one or more executed subtasks. For example, FIG. 4 shows signal indicating discrete interface device broadcast receiving module 492 receiving a signal indicating that the at least two discrete interface devices (e.g., the Dell Inspiron and the Motorola Xoom) are broadcasting data corresponding to a result of one or more executed subtasks (e.g., speed data from the subtask of “determine your speed traveling down Mercer St. on the Light Rail”).

Referring again to FIG. 8G, operation 892 may include operation 894 depicting receiving a signal from at least two discrete interface devices indicating that the at least two discrete interface devices are broadcasting data corresponding to a result of one or more executed subtasks. For example, FIG. 4 shows signal from discrete interface devices indicating discrete interface device broadcast receiving module 494 receiving a signal from at least two discrete interface devices (e.g., Asus Transformer and Pantech Pocket) indicating that the at least two discrete interface devices are broadcasting data corresponding to a result of one or more executed subtasks (e.g., image data from the subtask of “take a picture of the Pike Street fish market”).

Referring again to FIG. 8G, operation 892 may include operation 896 depicting receiving a signal from a service provider indicating that the at least two discrete interface devices are broadcasting data corresponding to a result of one or more executed subtasks. For example, FIG. 4 shows signal from service provider indicating discrete interface device broadcast receiving module 496 receiving a signal from a service provider (e.g., Google) indicating that the at least two discrete interface devices (e.g., Nokia Lumina and HTC Amaze) are broadcasting data corresponding to a result (e.g., image data) of one or more executed subtasks (e.g., take a picture of an interior of the Five Guys hamburgers chain at your position”).

Referring again to FIG. 8G, operation 888 may include operation 898 depicting predicting a time that at least two discrete interface devices are broadcasting data corresponding to a result of one or more executed subtasks. For example, FIG. 4 shows discrete interface device broadcast predicting module 498 predicting a time (e.g., 10:00 pm on the night of a show, based on what time the main act is taking the stage) that at least two discrete interface devices (e.g., Apple iPhone 4S and Samsung Galaxy SIT) are broadcasting data (e.g., loudness level data) corresponding to a result of one or more executed subtasks (e.g., “determine the loudness for the Red Hot Chili Peppers concert at your seat”).

Referring again to FIG. 8G, operation 888 may include operation 801 depicting detecting an occurrence of an event. For example, FIG. 4 shows event occurrence detection module 401 detecting an occurrence of an event (e.g., an earthquake).

Referring again to FIG. 8G, operation 888 may further include operation 803 depicting inferring, based on the event that at least two discrete interface devices are broadcasting data corresponding to a result of one or more executed subtasks. For example, FIG. 4 shows event-based discrete interface device broadcast inferring module 403 inferring (e.g., using hardware or software, or both, to determine a likelihood) based on the event (e.g., the earthquake) that at least two discrete interface devices (e.g., HTC Evo 3G, Kindle Fire) are broadcasting data corresponding to a result of one or more executed subtasks (e.g., image data from a subtask of “take a picture of Main Street,” e.g. for a task of assessing damage, or determining the best city egress routes).

Referring again to FIG. 8G, operation 803 may include operation 805 depicting inferring that at least two discrete interface devices are broadcasting data corresponding to a result of one or more executed subtasks that are related to the event. For example, FIG. 4 shows related event-based discrete interface device broadcast inferring module 405 inferring that at least two discrete interface devices (e.g., Samsung Galaxy Tab, Sony Tablet S) are broadcasting data (e.g., barometer data) corresponding to a result of one or more executed subtasks (e.g., “measure the drop in barometric pressure at your location”) that are related to the event (e.g., a hurricane).

Referring now to FIG. 8H, operation 506 may include operation 851 depicting acquiring a list of discrete interface devices. For example, FIG. 4 shows discrete interface device list acquiring module 451 acquiring (e.g., receiving from a source, or generating, or creating, or retrieving from a database or from a memory or storage) a list of discrete interface devices (e.g., a list of devices, either subscribers to a service, or visible devices on a network, or any list, either partially retrieved, fully retrieved, or retrieved as needed, or created or generated, from any location).

Referring again to FIG. 8H, operation 506 may include operation 853 depicting polling the discrete interface devices to obtain a result of one or more subtasks executed by at least two of the discrete interface devices in the absence of information regarding the at least one task and/or the task requestor. For example, FIG. 4 shows discrete interface device executed subtask result polling module 453 polling (e.g., sending a request for something to one or more devices, where the exact number and identity of the devices may be partially known) the discrete interface devices to obtain a result (e.g., image data) of one or more executed subtasks (e.g., “take a picture of the Space Needle”) executed by at least two of the discrete interface devices (e.g., BlackBerry Playbook and Kodak Playsport) in the absence of information regarding the at least one task and/or the task requestor.

Referring again to FIG. 8H, operation 853 may include operation 855 depicting polling the discrete interface devices to obtain a result of one or more executed subtasks executed by at least two of the discrete interface devices in response to a triggering event. For example, FIG. 4 shows event-triggered discrete interface device executed subtask result polling module 455 polling the discrete interface devices (e.g., e.g., sending a request for something to one or more devices, where the exact number and identity of the devices may be partially known) to obtain a result of one or more subtasks (e.g., loudness data from the subtask of “determine the loudness at a concert when Miley Cyrus takes the stage”) executed by at least two of the discrete interface devices (e.g., an Apple iPhone and a Palm Pre) in response to a triggering event (e.g., Miley Cyrus coming onstage).

Referring again to FIG. 8H, operation 855 may include operation 857 depicting polling the discrete interface devices in response to a triggering event, to obtain a result of one or more executed subtasks executed by at least two of the discrete interface devices and related to the triggering event. For example, FIG. 4 shows event-triggered discrete interface device event-related subtask result polling module 457 polling the discrete interface devices in response to a triggering event (e.g., the Seattle Seahawks score a touchdown), to obtain a result of one or more executed subtasks (e.g., image data from a subtask of “capture image data of the playing field as the Seattle Seahawks wide receiver catches a pass from your location”) executed by at least two of the discrete interface devices (e.g., an Apple iPhone 4 and an Apple iPad 2) and related to the triggering event (e.g., the touchdown by the Seattle Seahawks).

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “capable of being operably coupled”, to each other to achieve the desired functionality. Specific examples of operably coupled include but are not limited to physically mateable and/or physically interacting components and/or wirelessly interactable and/or wirelessly interacting components and/or logically interacting and/or logically interactable components.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. In addition, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1. A computationally-implemented method, comprising:
receiving a request to carry out at ask of acquiring data requested by a task requestor;
acquiring one or more subtasks related to the task of acquiring data and configured to be carried out by discrete interface devices in an absence of information regarding the at least one task and/or the task requestor; and
obtaining a result of one or more executed subtasks executed by at least two of the discrete interface devices in the absence of information regarding the at least one task and/or the task requestor.

2. The computationally-implemented method of claim 1, wherein said receiving a request to carry out a task of acquiring data requested by a task requestor comprises:
receiving a request to carry out a task of acquiring data capable of being carried out by receiving at least two responses to at least one query.

3. (canceled)

4. The computationally-implemented method of claim 1, wherein said receiving a request to carry out a task of acquiring data requested by a task requestor comprises:
receiving a request to carry out a task of acquiring and processing image data.

5. The computationally-implemented method of claim 1, wherein said receiving a request to carry out a task of acquiring data requested by a task requestor comprises:
receiving a request to carry out a task of acquiring data from a requesting discrete interface device.

6. (canceled)

7. The computationally-implemented method of claim 1, wherein said receiving a request to carry out a task of acquiring data requested by a task requestor comprises:
receiving a request to carry out a task of acquiring data requested by a particular service provider.

8. The computationally-implemented method of claim 7, wherein said receiving a request to carry out a task of acquiring data requested by a particular service provider comprises:
receiving a request to carry out a task of acquiring data requested by a social network provider.

9. The computationally-implemented method of claim 8, wherein said receiving a request to carry out a task of acquiring data requested by a social network provider comprises:
receiving a request to carry out a task of acquiring data requested by a user of a social network and received from a provider of the social network.

10. The computationally-implemented method of claim 8, wherein said receiving a request to carry out a task of acquiring data requested by a social network provider comprises:
receiving a request to carry out a task of acquiring data requested by a member of a social network and received from a provider of the social network.

11. The computationally-implemented method of claim 7, wherein said receiving a request to carry out a task of acquiring data requested by a particular service provider comprises:
receiving a request to carry out a task of acquiring data from a provider of an internet search engine.

12. The computationally-implemented method of claim 7, wherein said receiving a request to carry out a task of acquiring data requested by a particular service provider comprises:
receiving a request to carry out a task of acquiring data from a provider of an interface device operating system.

13. (canceled)

14. The computationally-implemented method of claim 1, wherein said acquiring one or more subtasks related to the task of acquiring data and configured to be carried out by discrete interface devices in an absence of information regarding the at least one task and/or the task requestor comprises:
acquiring one or more subtasks related to the task of acquiring data and configured to be carried out by discrete interface devices with incomplete information regarding the task requestor and/or the task of acquiring data.

15. The computationally-implemented method of claim 1, wherein said acquiring one or more subtasks related to the task of acquiring data and configured to be carried out by discrete interface devices in an absence of information regarding the at least one task and/or the task requestor comprises:
acquiring one or more subtasks related to the task of acquiring data and configured to be carried out by discrete interface devices with less information than would be present on a device carrying out the task of acquiring data.

16. The computationally-implemented method of claim 1, wherein said acquiring one or more subtasks related to the task of acquiring data and configured to be carried out by discrete interface devices in an absence of information regarding the at least one task and/or the task requestor comprises:
acquiring one or more subtasks related to the task of acquiring data and configured to be carried out by discrete interface devices with insufficient information to carry out the task of acquiring data.

17. The computationally-implemented method of claim 1, wherein said acquiring one or more subtasks related to the task of acquiring data and configured to be carried out by discrete interface devices in an absence of information regarding the at least one task and/or the task requestor comprises:
acquiring one or more subtasks related to the task of acquiring data and configured to be carried out by discrete interface devices in an absence of information regarding the at least one task.

18. (canceled)

19. The computationally-implemented method of claim 1, wherein said acquiring one or more subtasks related to the task of acquiring data and configured to be carried out by discrete interface devices in an absence of information regarding the at least one task and/or the task requestor comprises:
acquiring one or more subtasks related to the task of acquiring data and configured to be carried out by discrete interface devices in an absence of information regarding an objective of the task requestor.

20. (canceled)

21. (canceled)

22. (canceled)

23. (canceled)

24. (canceled)

25. (canceled)

26. The computationally-implemented method of claim 1, wherein said acquiring one or more subtasks related to the task of acquiring data and configured to be carried out by discrete interface devices in an absence of information regarding the at least one task and/or the task requestor comprises:
creating one or more subtasks related to the task of acquiring data.

27. (canceled)

28. The computationally-implemented method of claim 1, wherein said acquiring one or more subtasks related to the task of acquiring data and configured to be carried out by discrete interface devices in an absence of information regarding the at least one task and/or the task requestor comprises:
acquiring one or more subtasks whose executed result may be combined into a result of the task of acquiring data.

29. The computationally-implemented method of claim 1, wherein said acquiring one or more subtasks related to the task of acquiring data and configured to be carried out by discrete interface devices in an absence of information regarding the at least one task and/or the task requestor comprises:
acquiring one or more subtasks corresponding to portions of the task of acquiring data.

30. (canceled)

31. (canceled)

32. (canceled)

33. (canceled)

34. The computationally-implemented method of claim 1, wherein said obtaining a result of one or more executed subtasks executed by at least two of the discrete interface devices in the absence of information regarding the at least one task and/or the task requestor comprises:
selecting two or more discrete interface devices configured to carry out the one or more subtasks;
transmitting the one or more subtasks to the selected two or more discrete interface devices; and
receiving a result of one or more executed subtasks from at least two of the selected two or more discrete interface devices.

35. (canceled)

36. The computationally-implemented method of claim 1, wherein said obtaining a result of one or more executed subtasks executed by at least two of the discrete interface devices in the absence of information regarding the at least one task and/or the task requestor comprises:
transmitting the one or more subtasks to two or more discrete interface devices; and
receiving a result of one or more executed subtasks from at least two of the two or more discrete interface devices.

37. The computationally-implemented method of claim 1, wherein said obtaining a result of one or more executed subtasks executed by at least two of the discrete interface devices in the absence of information regarding the at least one task and/or the task requestor comprises:
obtaining a result of one or more executed subtasks executed by at least two discrete interface devices having a particular property.

38. The computationally-implemented method of claim 1, wherein said obtaining a result of one or more executed subtasks executed by at least two of the discrete interface devices in the absence of information regarding the at least one task and/or the task requestor comprises:
obtaining a result of one or more executed subtasks executed by at least two discrete interface devices determined to have a particular property.

39. The computationally-implemented method of claim 38, wherein said obtaining a result of one or more executed subtasks executed by at least two discrete interface devices determined to have a particular property comprises:
obtaining a result of one or more executed subtasks executed by at least two discrete interface devices determined to have a particular status and/or characteristic.

40. The computationally-implemented method of claim 39, wherein said obtaining a result of one or more executed subtasks executed by at least two discrete interface devices determined to have a particular status and/or characteristic comprises:
obtaining a result of one or more executed subtasks executed by at least two discrete interface devices determined to have a particular status.

41. (canceled)

42. (canceled)

43. The computationally-implemented method of claim 39, wherein said obtaining a result of one or more executed subtasks executed by at least two discrete interface devices determined to have a particular status and/or characteristic comprises:
obtaining a result of one or more executed subtasks executed by at least two discrete interface devices determined to have a particular characteristic.

44. (canceled)

45. (canceled)

46. The computationally-implemented method of claim 1, wherein said obtaining a result of one or more executed subtasks executed by at least two of the discrete interface devices in the absence of information regarding the at least one task and/or the task requestor comprises:
determining one or more properties of discrete interface devices necessary to carry out the one or more subtasks;
transmitting the one or more subtasks to two or more discrete interface devices having the one or more determined properties; and
receiving a result of one or more executed subtasks from at least two of the two or more discrete interface devices.

47. (canceled)

48. (canceled)

49. (canceled)

50. (canceled)

51. (canceled)

52. (canceled)

53. (canceled)

54. (canceled)

55. The computationally-implemented method of claim 1, wherein said obtaining a result of one or more executed subtasks executed by at least two of the discrete interface devices in the absence of information regarding the at least one task and/or the task requestor comprises:
determining one or more preferred properties of discrete interface devices to carry out the one or more subtasks;
transmitting the one or more subtasks to two or more discrete interface devices having the one or more determined preferred properties; and
receiving a result of one or more executed subtasks from at least two of the two or more discrete interface devices.

56. The computationally-implemented method of claim 55, wherein said determining one or more preferred properties of discrete interface devices to carry out the one or more subtasks comprises:
determining one or more properties of discrete interface devices that are favored but not necessary to carry out the one or more subtasks.

57. (canceled)

58. (canceled)

59. (canceled)

60. The computationally-implemented method of claim 1, wherein said obtaining a result of one or more executed subtasks executed by at least two of the discrete interface devices in the absence of information regarding the at least one task and/or the task requestor comprises:
receiving a result of one or more executed subtasks executed by at least two of the discrete interface devices in the absence of information regarding the at least one task and/or the task requestor.

61. The computationally-implemented method of claim 60, wherein said receiving a result of one or more executed subtasks executed by at least two of the discrete interface devices in the absence of information regarding the at least one task and/or the task requestor comprises:
receiving a result of one or more executed subtasks executed by at least two of the discrete interface devices, from at least two of the discrete interface devices.

62. (canceled)

63. (canceled)

64. (canceled)

65. (canceled)

66. (canceled)

67. (canceled)

68. The computationally-implemented method of claim 1, wherein said obtaining a result of one or more executed subtasks executed by at least two of the discrete interface devices in the absence of information regarding the at least one task and/or the task requestor comprises:
broadcasting a signal requesting transmission of a result of one or more executed subtasks; and
receiving the result of one or more executed subtasks by at least two or more discrete interface devices.

69. The computationally-implemented method of claim 68, wherein said broadcasting a signal requesting transmission of a result of one or more executed subtasks comprises:
broadcasting a signal over at least one wireless network, the signal requesting transmission of a result of one or more executed subtasks.

70. (canceled)

71. (canceled)

72. The computationally-implemented method of claim 68, wherein said broadcasting a signal requesting transmission of a result of one or more executed subtasks comprises:
broadcasting a signal using at least one social networking service, the signal requesting transmission of a result of one or more executed subtasks.

73. (canceled)

74. (canceled)

75. The computationally-implemented method of claim 1, wherein said obtaining a result of one or more executed subtasks executed by at least two of the discrete interface devices in the absence of information regarding the at least one task and/or the task requestor comprises:
determining that at least two discrete interface devices are broadcasting data corresponding to a result of one or more executed subtasks; and
receiving broadcasted data corresponding to the result of one or more executed subtasks.

76. (canceled)

77. (canceled)

78. (canceled)

79. (canceled)

80. The computationally-implemented method of claim 75, wherein said determining that at least two discrete interface devices are broadcasting data corresponding to a result of one or more executed subtasks comprises:
detecting an occurrence of an event; and
inferring, based on the event that at least two discrete interface devices are broadcasting data corresponding to a result of one or more executed subtasks.

81. The computationally-implemented method of claim 80, wherein said inferring, based on the event that at least two discrete interface devices are broadcasting data corresponding to a result of one or more executed subtasks comprises:
inferring that at least two discrete interface devices are broadcasting data corresponding to a result of one or more executed subtasks that are related to the event.

82. The computationally-implemented method of claim 1, wherein said obtaining a result of one or more executed subtasks executed by at least two of the discrete interface devices in the absence of information regarding the at least one task and/or the task requestor comprises:
acquiring a list of discrete interface devices; and
polling the discrete interface devices to obtain a result of one or more subtasks executed by at least two of the discrete interface devices in the absence of information regarding the at least one task and/or the task requestor.

83. The computationally-implemented method of claim 82, wherein said polling the discrete interface devices to obtain a result of one or more subtasks executed by at least two of the discrete interface devices in the absence of information regarding the at least one task and/or the task requestor comprises:
polling the discrete interface devices to obtain a result of one or more executed subtasks executed by at least two of the discrete interface devices in response to a triggering event.

84. The computationally-implemented method of claim 83, wherein said polling the discrete interface devices to obtain a result of one or more executed subtasks executed by at least two of the discrete interface devices in response to a triggering event comprises:
polling the discrete interface devices in response to a triggering event, to obtain a result of one or more executed subtasks executed by at least two of the discrete interface devices and related to the triggering event.

85. A computationally-implemented system comprising:
means for receiving a request to carry out a task of acquiring data requested by a task requestor;
means for acquiring one or more subtasks related to the task of acquiring data and configured to be carried out by discrete interface devices in an absence of information regarding the at least one task and/or the task requestor; and
means for obtaining a result of one or more executed subtasks executed by at least two of the discrete interface devices in the absence of information regarding the at least one task and/or the task requestor.

86-170. (canceled)
